(19) United States
(12) Patent Application Publication
(10) Pub. No.: US 2026/0206059 A1
(43) Pub. Date: Jul. 16, 2026

(54) TERMINAL, RADIO COMMUNICATION METHOD, AND BASE STATION

(71) Applicant: NTT DOCOMO, INC., Tokyo (JP)

(72) Inventors: Naoya SHIBAIKE, Tokyo (JP); Yuki MATSUMURA, Tokyo (JP); Satoshi NAGATA, Tokyo (JP); Qiping PI, Beijing (CN); Jing WANG, Beijing (CN); Lan CHEN, Beijing (CN); Yiyi LU, Beijing (CN); Yong LI, Beijing (CN)

(73) Assignee: NTT DOCOMO, INC., Tokyo (JP)

(21) Appl. No.: 18/879,306

(22) PCT Filed: Jul. 5, 2022
(86) PCT No.: PCT/JP2022/026724

§ 371 Date: Dec. 27, 2024

(51) Int. Cl. H04W 74/0833; H04L 1/08

(52) U.S. Cl. CPC H04W 74/0833; H04L 1/08

(57) ABSTRACT

A terminal according to an aspect of the present disclosure includes a receiving section that receives indication information related to the number of repetitions of a message 3, and a control section that determines the number of repetitions of the message 3, based on the indication information and information related to a repetition of a message 1 in random access procedure including a repetition of the message 3. According to an aspect of the present disclosure, it is possible to enhance coverage in random access procedure.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, NR), coverage enhancement is under study.

However, random access procedure for the coverage enhancement is indefinite. Unless such random access procedure is definite, communication throughput may be reduced.

Thus, an object of the present disclosure is to provide a terminal, a radio communication method, and a base station that enhance coverage in random access procedure.

### Solution to Problem

A terminal according to an aspect of the present disclosure includes a receiving section that receives indication information related to the number of repetitions of a message 3, and a control section that determines the number of repetitions of the message 3, based on the indication information and information related to a repetition of a message 1 in random access procedure including a repetition of the message 3.

### Advantageous Effects of Invention

According to an aspect of the present disclosure, it is possible to enhance coverage in random access procedure.

### BRIEF DESCRIPTION OF DRAWINGS

FIGS. 1A and 1B show examples of multi-PRACH transmission.

FIG. 2 shows an example of a relationship between a PRACH mask index and an allowed PRACH occasion (RO) of an SSB.

FIG. 3 shows an example of a relationship between a value (codepoint) of 2 MSBs of an MCS information field and the number K of repetitions.

FIGS. 4A and 4B show examples of a relationship between Msg1 and Msg2.

FIG. 5 shows an example of RACH procedure for RSRP of a DL pathloss reference according to Embodiment #1a-1.

FIG. 6 shows an example of RACH procedure for RSRP of a DL pathloss reference according to Example 1 of Embodiment #1a-2.

FIG. 7 shows an example of RACH procedure for RSRP of a DL pathloss reference according to Example 2 of Embodiment #1a-2.

FIG. 8 shows an example of RACH procedure for RSRP of a DL pathloss reference according to Embodiment 1a-3.

FIGS. 9A and 9B show examples of an application condition according to Embodiment #1a-4.

FIG. 10 shows an example of an RSRP threshold.

FIG. 11 shows an example of Transmission Beam 1-1A.

FIG. 12 shows another example of Transmission Beam 1-1A.

FIG. 13 shows an example of Transmission Beam 1-1B.

FIG. 14 shows a first example of Transmission Beam 1-2A.

FIG. 15 shows a second example of Transmission Beam 1-2A.

FIG. 16 shows a third example of Transmission Beam 1-2A.

FIG. 17 shows a fourth example of Transmission Beam 1-2A.

FIG. 18 shows an example of Transmission Beam 2-1A.

FIG. 19 shows another example of Transmission Beam 2-1A.

FIG. 20 shows an example of Transmission Beam 2-2A.

FIG. 21 shows another example of Transmission Beam 2-2A.

FIGS. 22A to 22C show examples of candidate values for the number of Msg3 repetitions.

FIG. 23 is a diagram to show an example of a schematic structure of a radio communication system according to one embodiment.

FIG. 24 is a diagram to show an example of a structure of a base station according to one embodiment.

FIG. 25 is a diagram to show an example of a structure of a user terminal according to one embodiment.

FIG. 26 is a diagram to show an example of a hardware structure of the base station and the user terminal according to one embodiment.

FIG. 27 is a diagram to show an example of a vehicle according to one embodiment.

### DESCRIPTION OF EMBODIMENTS

(TCI, Spatial Relation, QCL)

For NR, it is studied that reception processing (for example, at least one of reception, demapping, demodulation, and decoding) and transmission processing (for example, at least one of transmission, mapping, precoding, modulation, and coding) of at least one of a signal and a channel (expressed as a signal/channel) in a UE are controlled based on a transmission configuration indication state (TCI state).

The TCI state may be a state applied to a downlink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information, or the like.

The TCI state may be configured for the UE for each channel or for each signal. QCL is an indicator indicating statistical properties of the signal/channel. For example, when a given signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have different parameter(s) (or parameter set(s)) that can be assumed to be the same, and such parameter(s) (which may be referred to as QCL parameter(s)) are described below:
QCL type A (QCL-A): Doppler shift, Doppler spread, average delay, and delay spread
QCL type B (QCL-B): Doppler shift and Doppler spread
QCL type C (QCL-C): Doppler shift and average delay
QCL type D (QCL-D): Spatial reception parameter

A case that the UE assumes that a given control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

The physical layer signaling may be, for example, downlink control information (DCI).

A channel for which the TCI state or spatial relation is configured (specified) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), and a reference signal for QCL detection (also referred to as a QRS).

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An RS of QCL type X in a TCI state may mean an RS in a relationship of QCL type X with (a DMRS of) a given channel/signal, and this RS may be referred to as a QCL source of QCL type X in the TCI state.

### (Initial Access Procedure)

In initial access procedure, a UE (RRC IDLE mode) performs reception of an SS/PBCH block (SSB), transmission of Msg. 1 (PRACH/random access preamble/preamble), reception of Msg. 2 (PDCCH, PDSCH including a random access response (RAR)), transmission of Msg. 3 (PUSCH scheduled by an RAR UL grant), and reception of Msg. 4 (PDCCH, PDSCH including a UE contention resolution identity). Subsequently, when an ACK for Msg. 4 is transmitted from the UE by a base station (network), an RRC connection is established (RRC_CONNECTED mode).

The reception of the SSB includes PSS detection, SSS detection, PBCH-DMRS detection, and PBCH reception. The PSS detection performs detection of part of a physical cell ID (PCI), detection (synchronization) of an OFDM symbol timing, and (rough) frequency synchronization. The SSS detection includes detection of a physical cell ID. The PBCH-DMRS detection includes detection of (part of) an SSB index in a half radio frame (5 ms). The PBCH reception includes detection of a system frame number (SEN) and a radio frame timing (SSB index), reception of configuration information for remaining minimum system information (RMSI, SIB1) reception, and recognition of whether the UE can camp on the cell (carrier).

The SSB includes a band of 20 RBs and time of 4 symbols. A transmission periodicity of the SSB is configurable from {5, 10, 20, 40, 80, 160} ms. In the half frame, a plurality of symbol locations of the SSB are defined based on a frequency range (FR1, FR2).

The PBCH includes a 56-bit payload. N repetitions of the PBCH are transmitted in a periodicity of 80 ms. N depends on the transmission periodicity of the SSB.

The system information is constituted by an MIB delivered by the PBCH, RMSI (SIB1), and other system information (OSI). SIB1 includes a RACH configuration and information for RACH procedure. A time/frequency resource relationship between the SSB and a PDCCH monitoring resource for SIB1 is configured by the PBCH.

The base station using beam correspondence transmits a plurality of respective SSBs by using a plurality of beams for each SSB transmission periodicity. The plurality of SSBs include a plurality of respective SSB indices. The UE that has detected one SSB transmits a PRACH in a RACH occasion associated with the SSB index, and receives an RAR in an RAR window.

### (Beam and Coverage)

In a high frequency band, unless beam forming is applied to a synchronization signal/reference signal, coverage becomes narrow, and it is difficult for the UE to identify the base station. On the other hand, applying the beam forming to the synchronization signal/reference signal to secure coverage allows a strong signal to be delivered in a specific direction, but makes it more difficult for signals to be delivered in directions other than the direction. Assuming that a direction in which the UE exists is unknown for the base station before the UE is connected, the base station fails to transmit a synchronization signal/reference signal by using a beam only in an appropriate direction. A method in which the base station transmits a plurality of synchronization signals/reference signals including respective beams in different directions and recognizes which beam is identified by the UE is conceivable. Using thin (narrow) beams for coverage requires many synchronization signals/reference signals to be transmitted, and thus overhead may increase, and frequency use efficiency may be reduced.

Using thick (broad) beams to suppress overhead by reducing the number of beams (synchronization signals/reference signals) narrows coverage.

In future radio communication systems (for example, 6G), it is conceivable that use of frequency bands, such as millimeter waves and terahertz waves, advances further. It is conceivable that communication services are provided by constructing a cell area/coverage by using multiple thin beams.

Area expansion using existing FR2 and use of a frequency band higher than existing FR2 are conceivable. For achieving these, improvement of beam management in addition to multi-TRP, reconfigurable intelligent surface (RIS), and the like is preferable.

Coverage enhancement including PRACH enhancement for frequency range (FR) 2 is under study. For example, PRACH repetition using the same beam or a plurality of different beams is under study. This PRACH enhancement may be applied to FR1.

PRACH enhancement may be applied to a short PRACH format or another format.

A common RACH configuration (RACH-ConfigCommon) may include a generic RACH configuration (rach-ConfigGeneric), a total number of RA preambles (totalNumberOfRA-Preambles), and an SSB per RACH occasion and contention-based (CB) preambles per SSB (ssb-perRACH-OccasionAndCB-PreamblesPerSSB). rach-ConfigGeneric may include a PRACH configuration index (prach-ConfigurationIndex) and message 1 FDM (msg1-FDM, the number of PRACH occasions FDMed in one time instance). ssb-perRACH-OccasionAndCB-PreamblesPerSSB may include the number of CB preambles per SSB for the number 1/8 of SSBs per RACH occasion (oneEighth, one SSB being associated with 8 RACH occasions).

For type 1 random access procedure (4-step random access procedure, message 1/2/3/4), the number N of SS/PBCH blocks associated with one PRACH occasion and the number R of CB preambles per enabled PRACH occasion and per SS/PBCH block may be applied for the UE by ssb-perRACH-OccasionAndCB-PreamblesPerSSB.

For the type 1 random access procedure or for type 2 random access procedure (2-step random access procedure, message A/B) with PRACH occasion configuration independent of the type 1 random access procedure, if N<1, one SS/PBCH block is mapped to 1/N consecutive enabled RACH occasions, and R CB preambles with consecutive indices associated with an SS/PBCH block index for each enabled PRACH occasion start from preamble index 0. If N≥1, R CB preambles with consecutive indices associated with SS/PBCH block index n (0≤n≤N−1) for each enabled PRACH occasion start from preamble index n. N preamble\hat{ }total/N. Here, N preamble\hat{ }total is given by totalNumberOfRA-Preambles for the type 1 random access procedure, and is given by msgA-TotalNumberOfRA-Preambles for the type 2 random access procedure with the PRACH occasion configuration independent of the type 1 random access procedure. N preamble\hat{ }total is a multiple of N.

An association period starting from frame 0, for mapping SS/PBCH blocks to PRACH occasions is a minimum value in a set determined by a PRACH configuration period in accordance with a relationship (relationship defined in a specification) between a PRACH configuration period and an association period (the number of PRACH configuration periods) so that N_Tx\hat{ }SSB SS/PBCH block indices are mapped to PRACH occasions at least one time in the association period. Here, the UE obtains N_Tx\hat{ }SSB from values of SSB positions in a burst (ssb-PositionsInBurst) in SIB1 or in common serving cell configuration (ServingCellConfigCommon). If a set of PRACH occasions or PRACH preambles not mapped to N_Tx\hat{ }SSB SS/PBCH block indices is present after an integer number of cycles of mapping from SS/PBCH block indices to PRACH occasions in the association period, none of the SS/PBCH block indices is mapped to the set of PRACH occasions or PRACH preambles. An association pattern period includes one or more association periods, and is determined so that a PRACH occasion and a pattern between SS/PBCH block indices repeat every 160 ms at most. If a PRACH occasion not associated with SS/PBCH block indices after an integer number of association periods is present, the PRACH occasion is not used for a PRACH.

For PRACH configuration periods 10, 20, 40, 80, and 160 [msec], association periods are {1, 2, 4, 8, 16}, {1, 2, 4, 8}, {1, 2, 4}, {1, 2}, and {1}, respectively.

When ssb-perRACH-OccasionAndCB-PreamblesPerSSB for association between a PRACH occasion (RACH occasion (RO)) and a beam (SSB/CSI-RS) indicates oneHalf, n16 (N=1/2, R=16), and msg1-FDM is 4, four ROs are FDMed in one time instance, and one SSB is mapped to two ROs. Preamble indices 0 to 15 are associated with two ROs, and preamble indices 0 to 15 are associated with SSOB. Thus, when N<1, one SSB is mapped to a plurality of ROs. With this, RO capacity for each beam can be enhanced.

When ssb-perRACH-OccasionAndCB-PreamblesPerSSB indicates n4, n16 (N=4, R=16), msg1-FDM is 4, and N preamble\hat{ }total is 64, four ROs are FDMed in one time instance, and four SSBs are mapped to one RO. One RO is associated with SSBs 0 to 3. Preamble indices 0 to 15 are associated with SSB 0, preamble indices 15 to 31 are associated with SSB 1, preamble indices 32 to 47 are associated with SSB 2 SSB 2 is, and preamble indices 48 to 63 are associated with SSB 3 SSB 3 is. In this manner, the same RO is associated with different SS/PBCH block indices, and different preambles use different SS/PBCH block indices. The base station can distinguish between associated SS/PBCH block indices by using a received PRACH.

The random access preamble can be transmitted only in a time resource defined by random access configuration in a specification, and depends on whether the random access preamble is for FR1 or FR2, and a spectrum type (paired spectrum/supplementary uplink (SUL)/unpaired spectrum). The PRACH configuration index is given by a higher layer parameter “prach-ConfigurationIndex” or by “msgA-PRACH-ConfigurationIndex,” if configured. In the specification, each value of the PRACH configuration index is associated with at least one of a preamble format, x and y in n f (frame number) mod x=y, a subframe number, a start symbol, the number of PRACH slots in a subframe, the number N_t\hat{ }RA, slot of time-domain PRACH occasions in a PRACH slot, and PRACH duration N dur\hat{ }RA.

Types of RACH procedure triggered by different purposes, depending on whether PRACH repetition can be applied to a scenario, are different from each other. The types of the RACH procedure may be at least one of the following.
Contention-free random access (CFRA), PDCCH order RA (PDCCH ordered RA, RA initiated by PDCCH order), CFRA for beam failure recovery (BFR), CFRA for system information (SI) request, CFRA for reconfiguration with synchronization (reconfiguration with sync), and the like
Contention-based random access (CBRA), RA triggered by MAC entity, RA triggered by RRC with event, CBRA for BFR, and the like
4-step RACH
2-step RACH

However, configuration/procedure for the PRACH repetition is indefinite. For example, how to configure PRACH resources for the repetition (for example, a repetition pattern, the number of repetitions), UE operation for preamble repetition transmission, an impact on a RACH-related counter/timer, and the like are indefinite. Unless such configuration/procedure is clear, communication quality/communication throughput may deteriorate.

### (RA Response Window)

An RA response window (ra-ResponseWindow) is a time window for monitoring an RA response (RAR) (only in an SpCell). An RA contention resolution timer (ra-ContentionResolutionTimer) is a timer for RA contention resolution (only in an SpCell). A Msg. B response window is a time window for monitoring an RA response (RAR) for a 2-step RA type (only in an SpCell).

When an RA preamble is transmitted, a MAC entity performs Operations 1 to 3 below irrespective of a possibility of occurrence of a measurement gap.

### {Operation 1}

If a contention-free RA preamble for a BFR request has been transmitted by the MAC entity, the MAC entity performs Operations 1-1 and 1-2 below.

{{Operation 1-1}} The MAC entity starts, in the first PDCCH occasion since an end of the RA preamble transmission, ra-ResponseWindow configured in BFR configuration (BeamFailureRecoveryConfig).

{{Operation 1-2} While ra-ResponseWindow is operating, the MAC entity monitors PDCCH transmission in a search space indicated by a BFR search space ID (recoverySearchSpaceId) of an SpCell specified by a C-radio network temporary identifier (RNTI).

### {Operation 2}

Otherwise, the MAC entity performs Operations 2-1 and 2-2 below.

{{Operation 2-1}} The MAC entity starts, in the first PDCCH occasion since an end of the RA preamble transmission, ra-ResponseWindow configured in common RACH configuration (RACH-ConfigCommon). {{Operation 2-2}} While ra-ResponseWindow is operating, the MAC entity monitors PDCCH transmission in an SpCell for RAR specified by an RA-RNTI.

### {Operation 3}

If ra-ResponseWindow configured in BeamFailureRecoveryConfig has expired, and PDCCH transmission on a search space indicated by recoverySearchSpaceId for a C-RNTI has been received on a serving cell in which the preamble has been transmitted or if ra-ResponseWindow configured in RACH-ConfigCommon has expired, and an RAR including RA preamble identifiers corresponding to a transmitted preamble index (PREAMBLE INDEX) has been received, the MAC entity regards the RAR reception as unsuccessful, and increments a preamble transmission counter (PREAMBLE TRANSMISSION COUNTER) by 1.

The MAC entity may stop ra-ResponseWindow after success in receiving an RAR including RA preamble identifiers corresponding to transmitted PREAMBLE INDEX (may stop monitoring for the RAR).

For PDCCH monitoring in the RA response window, there are two cases of a PDCCH for a base station response to BFR and a PDCCH for an RAR. The following description may be applied to both of the cases.

When an MSGA (Msg. A) preamble is transmitted, a MAC entity performs Operations 4 to 6 below irrespective of a possibility of occurrence of a measurement gap.

### {Operation 4}

The MAC entity starts, in a PDCCH monitoring window defined in a specification, a Msg. B response window (msgB-ResponseWindow).

msgB-ResponseWindow may be started in the first symbol for the earliest CORESET in which the UE is configured to receive a PDCCH for a type 1-PDCCH CSS set being at least one symbol after the last symbol for a PRACH occasion corresponding to PRACH transmission. A length of msgB-ResponseWindow may correspond to SCS for the type 1-PDCCH CSS set.

### {Operation 5}

While msgB-ResponseWindow is operating, the MAC entity monitors PDCCH transmission in an SpCell for RAR specified by an MSGB-RNTI.

### {Operation 6}

If a C-RNTI MAC CE is included in the MSGA, while msgB-ResponseWindow is operating, the MAC entity monitors PDCCH transmission in an SpCell for RAR specified by a C-RNTI.

The RA-RNTI associated with a PRACH occasion in which the RA preamble is transmitted is calculated as follows.

$$RA - RNTI = 1 + s\_id + 14 \times t\_id + 14 \times 80 \times f\_id + 14 \times 80 \times 8 \times ul\_carrier \_id$$

Here, s id is an index of the first OFDM symbol for the PRACH occasion (0≤s id<14). t_id is an index of the first slot for the PRACH occasion in a system frame (0≤t_id<80). Subcarrier spacing (SCS) for determination of t_id is based on a value of u. f_id is an index of the PRACH occasion in a frequency domain (0≤ f_id<8). ul_carrier_id is a UL_carrier used for the RA preamble transmission (0 for a normal uplink (NUL) carrier, 1 for a supplementary uplink (SUL) carrier). The RA-RNTI is calculated in accordance with a specification. The RA-RNTI is an RNTI for the 4-step RACH.

The MSGB-RNTI associated with a PRACH occasion in which the RA preamble is transmitted is calculated as follows.

$$MSGB - RNTI = 1 + s\_id + 14 \times t\_id + 14 \times 80 \times f\_id + 14 \times 80 \times 8 \times ul\_carrier \_id + 14 \times 80 \times 8 \times 2$$

Here, s id is an index of the first OFDM symbol for the PRACH occasion (0≤s id<14). t_id is an index of the first slot for the PRACH occasion in a system frame (0<t_id<80). Subcarrier spacing (SCS) for determination of t_id is based on a value of u. f_id is an index of the PRACH occasion in a frequency domain (0≤ f_id<8). ul_carrier_id is a UL_carrier used for the RA preamble transmission (0 for a normal uplink (NUL) carrier, 1 for a supplementary uplink (SUL) carrier). The MSGB-RNTI is an RNTI for the 2-step RACH.

### (PDCCH Order)

### <DCI Format for PDCCH Order>

DCI format 1_0 includes a DCI format indicator field, a bit field always set to 1, and a frequency domain resource assignment field. When a cyclic redundancy check (CRC) with DCI format 1_0 is scrambled by a C-RNTI, and all the frequency domain resource assignment fields are 1, that DCI format 1_0 is for random access procedure initiated by a PDCCH order, and remaining fields are a random access preamble, a UL/supplementary Uplink (SUL) indicator, an SS/PBCH index (SSB index), a PRACH mask index, and a reserved bit (12 bits).

### <PRACH Occasion>

In a case of PRACH transmission triggered by the PDCCH order, when a value of a random access preamble index field is non-zero, a PRACH mask index field indicates a PRACH occasion for PRACH transmission for which a PRACH occasion is associated with an SS/PBCH block index indicated by an SS/PBCH block index field with the PDCCH order.

In a case of PRACH transmission triggered by a higher layer (PRACH transmission not triggered by the PDCCH order), if ssb-ResourceList is provided, the PRACH mask index is indicated by ra-ssb-OccasionMaskIndex. That ra-ssb-OccasionMaskIndex indicates a PRACH occasion for PRACH transmission for which the PRACH occasion is associated with a selected SS/PBCH block index.

PRACH occasions are mapped consecutively for each corresponding SS/PBCH block index. Indexing of PRACH occasions indicated by mask index values is reset for each SS/PBCH block index and for each mapping cycle of consecutive PRACH occasions. In the first available mapping cycle, the UE selects, for the PRACH transmission, a PRACH occasion indicated by a PRACH mask index value for an indicated SS/PBCH block index.

For an indicated preamble index, the order of the PRACH occasions is as follows.
Firstly, an increasing order of frequency resource indices for frequency multiplexed PRACH occasions,
secondly, an increasing order of time resource indices for time multiplexed PRACH occasions in PRACH slots, and
thirdly, an ascending order of PRACH slot indices.

If csirs-ResourceList is provided for PRACH transmission triggered in response to a request from the higher layer, a value of ra-OccasionList indicates a list of PRACH occasions for the PRACH transmission, and the PRACH occasions are associated with a selected CSI-RS index indicated by csi-RS. Indexing of PRACH occasions indicated by ra-OccasionList is reset for each association pattern period.

A value of the PRACH mask index value (msgA-SSB-SharedRO-MaskIndex) is associated with an allowed PRACH occasion (PRACH occasion index value) of an SSB.

### <Random Access Procedure in MAC Entity>

Random access procedure is initiated by RRC for an event following a PDCCH order, a MAC entity itself, or a specification. In the MAC entity, only one ongoing random access procedure is present at an arbitrary timing. Random access procedure for an SCell is initiated only by a PDCCH order with ra-PreambleIndex different from 0b000000.

When the random access procedure is initiated on a serving cell, the MAC entity performs the following.
Configuring RA TYPE as 4-stepRA when random access procedure is initiated by a PDCCH order, and ra-PreambleIndex explicitly provided by a PDCCH is not 0b000000 or when random access procedure is initiated for reconfiguration with synchronization, and a contention-free random access resource of a 4-step RA type is explicitly provided by rach-ConfigDedicated for a BWP selected for the random access procedure.

When selected RA TYPE is configured as 4-stepRA, the MAC entity performs the following.
Setting PREAMBLE INDEX to notified ra-PreambleIndex and selecting an SSB notified by the PDCCH, when ra-PreambleIndex is explicitly provided from the PDCCH, and ra-PreambleIndex is not 0b000000, and
determining, when the SSB is selected in such a manner as that described above, a subsequent available PRACH occasion from among PRACH occasions corresponding to the selected SSB and allowed by limitation given by ra-ssb-OccasionMaskIndex (The MAC entity randomly selects, with equal probability, a PRACH occasion from consecutive PRACH occasions corresponding to the selected SSB, in accordance with a specification. The MAC entity may consider a possibility of occurrence of a measurement gap when determining the subsequent available PRACH occasion corresponding to the selected SSB).

### <Time Between PDCCH Order Reception and PRACH Transmission>

If the random access procedure has been initiated by the PDCCH order, the UE transmits, if requested by the higher layer, a PRACH in a selected PRACH occasion in a case where time between the last symbol for PDCCH order reception and the first symbol for PRACH transmission is N_(T, 2)+Δ_BWPSwitching+Δ_Delay+T_switch [msec] or more (time condition), as described in a specification. Here, N_(T, 2) is duration of an N_2 symbol corresponding to PUSCH preparation time for UE processing capability 1. Assume that u corresponds to minimum SCS configuration between subcarrier spacing (SCS) configuration for the PDCCH order and SCS configuration for PRACH transmission corresponding to the PDCCH order. Δ_BWPSwitching=0 when an active UL BWP does not vary, otherwise Δ_BWPSwitching is defined in the specification. In FR1, A delay=0.5 msec, and in FR2, A delay=0.25 msec. T_switch is switching gap duration defined in the specification.

### <Condition for Validity/Invalidity of PRACH Occasion (Validity Condition)>

In a paired spectrum (FDD) or an SUL band, all the PRACH occasions are valid. In an unpaired spectrum (TDD), the PRACH occasions may follow Requirement 1 and Requirement 2 below.

### {Requirement 1}

In a case where the UE is not provided with tdd-UL-DL-ConfigurationCommon, when a PRACH occasion in a PRACH slot starts at least N_gap symbols after the last SS/PBCH block reception symbol without preceding an SS/PBCH block in the PRACH slot, the PRACH occasion is valid. Here, N_gap is defined in a specification. When channelAccessMode=semistatic is provided, the PRACH occasion does not overlap a set of consecutive symbols before a start of a subsequent channel occupancy time in which the UE does not perform transmission. A candidate SS/PBCH block index of the SS/PBCH block corresponds to an SS/PBCH block index provided by ssb-PositionsInBurst in SIB1 or in ServingCellConfigCommon.

### {Requirement 2}

When the UE is provided with tdd-UL-DL-ConfigurationCommon, the PRACH occasion in the PRACH slot is valid in the following case.
The PRACH occasion is present in a UL symbol, or
the PRACH occasion starts at least N_gap symbols after the last DL symbol and at least N_gap symbols after the last SS/PBCH block symbol without preceding an SS/PBCH block in a PRACH slot. Here, N_gap is defined in a specification. If channelAccessMode=semistatic is provided, as described in the specification, the PRACH occasion does not overlap a set of consecutive symbols before a start of a subsequent channel occupancy time in which any transmission is not allowed. As described in the specification, a candidate SS/PBCH block index of the SS/PBCH block corresponds to an SS/PBCH block index provided by ssb-PositionsInBurst in SIB1 or in ServingCellConfigCommon.

### (Step 4 in CBRA)

Step 4 (Msg4) in RA procedure in Rel-16 NR follows Step 4 Operation below.

### {Step 4 Operation}

When the UE is not provided with a C-RNTI, the UE attempts to detect DCI format 1_0 with a CRC scrambled by a corresponding TCI-RNTI and for scheduling a PDCSH including a UE contention resolution identity, in response to PUSCH transmission scheduled by an RAR UL grant. In response to reception of the PDSCH including the UE contention resolution identity, the UE transmits HARQ-ACK information in a PUCCH. The PUCCH transmission is performed in the same active UL BWP as that for the PUSCH transmission. Minimum time between the last symbol for the PDSCH reception and the first symbol for the corresponding PUCCH transmission including the HARQ-ACK information is equal to N_T, 1 [msec]. N_T, 1 is duration of N_T, 1 symbols corresponding to PDSCH processing time for UE processing capability 1 in a case where an additional PDSCH DM-RS is configured. For u=0, the UE assumes N_T, 1=14.

When detecting a DCI format in response to PUSCH transmission scheduled by an RAR UL grant or in response to corresponding PUSCH retransmission scheduled by DCI format 0_0 with a CRC scrambled by a TC-RNTI provided by a corresponding RAR message, the UE may assume, for a PDCCH that delivers the DCI format, the same DM-RS antenna port quasi co-location (QCL) properties as DM-RS antenna port QCL properties for an SS/PBCH block used by the UE for PRACH association, irrespective of whether the UE is provided with a TCI state for a CORESET with which the UE has received the PDCCH with the DCI format.

### (RAR Reception)

In response to PRACH transmission, the UE attempts to detect, in a window controlled by the above-described higher layer, DCI format 1_0 with a CRC scrambled by a corresponding RA-RNTI. The window starts in the first symbol for the earliest CORESET in which the UE is configured to receive a PDCCH for a type 1-PDCCH CSS set, that is, at least 1 symbol after the last symbol for a PRACH occasion corresponding to the PRACH transmission. The symbol period corresponds to SCS for the type 1-PDCCH CSS set. A length of the window is provided as the number of slots by ra-responseWindow, based on the SCS for the type 1-PDCCH CSS set.

If the UE has detected DCI format 1_0 with the CRC scrambled by the corresponding RA-RNTI and the same least significant bits (LSBs) of an SFN field in the DCI format as LSBs of a system frame number (SFN) in which the UE has transmitted a PRACH, and the UE has received a transport block in a corresponding PDSCH, the UE may assume the same DMRS antenna port QCL properties in relation to an SS/PBCH block or a CSI-RS resource used by the UE for association of the PRACH, irrespective of whether the UE is provided with a TCI state (TCI-State) for a CORESET for receiving a PDCCH with DCI format 1_0.

If the UE attempts to detect DCI format 1_0 with a CRC scrambled by a corresponding RA-RNTI, in response to PRACH transmission initiated by a PDCCH order for triggering CFRA procedure for an SpCell, the UE may assume that a PDCCH including DCI format 1_0 and the PDCCH order have the same DMRS antenna port QCL properties. If the UE attempts to detect DCI format 1_0 with a CRC scrambled by a corresponding RA-RNTI, in response to PRACH transmission initiated by a PDCCH order for triggering CFRA procedure for a secondary cell, the UE may assume DMRS antenna port QCL properties of a CORESET associated with a type 1-PDCCH CSS set for reception of a PDCCH including DCI format 1_0.

The RAR UL grant may include at least one of a frequency hopping flag field, a PUSCH frequency resource allocation field, a PUSCH time resource allocation field, a modulation and coding scheme (MCS) field, a TPC command field for PUSCH, a CSI request field, and a channel access-cyclic prefix extension (CPext) field.

### (Uplink Coverage Enhancement for PRACH)

The following two cases/types of multi-PRACH transmission are under study.

### {Case 1/Type 1 Multi-PRACH Transmission}

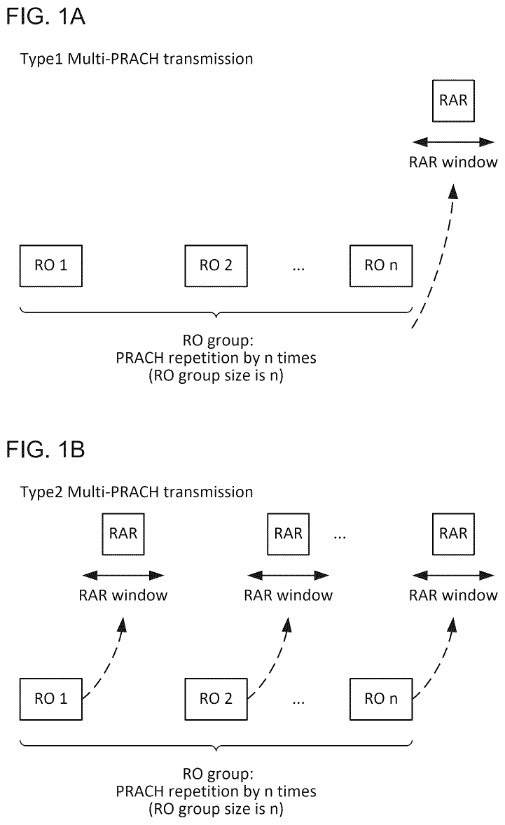

The UE performs repetition transmission of Msg1 on n random access occasions (ROs)/RO resources. Subsequently, the UE waits for detection of Msg2 in a configured type 1 PDCCH occasion. In the present disclosure, preamble repetition transmission in n ROs resources is sometimes referred to as an RO group. FIG. 1A shows an example of a timing of the type 1 multi-PRACH transmission. In this example, a size of the RO group (the number of Ros in the RO group) is n. One RAR window is started after one RO group.

{Case 2/Type 2 Multi-PRACH Transmission}

The UE performs repetition transmission of Msg1 on n random access occasion (RO) resources. After transmission of Msg1 on each RO, the UE waits for detection of Msg2 in a type 1 PDCCH occasion. FIG. 1B shows an example of a timing of the type 2 multi-PRACH transmission. In this example, a size of the RO group (the number of ROs in the RO group) is n. One RAR window is started after each RO.

### (Rel-17 Msg3 Repetition)

The UE determines whether to apply Msg3 repetition, based on RSRP. When Msg repetition is configured, and RSRP of a DL pathloss reference is less than rsrp-ThresholdMsg3 (threshold), a MAC entity assumes that Msg3 repetition is applicable to current random access (RA) procedure.

The UE can request Msg3 PUSCH repetition via a dedicated PRACH resource. The MAC entity selects RA resources in a case where one or more sets of available RA resources are present and where one of the one or more sets is used to indicate all the features for triggering this RA procedure and a case where one or more sets of available RA resources in which indication for a subset of all the features for triggering this RA procedure is configured. When Msg3 repetition is unavailable in a case where Msg3 repetition indication is configured for an RA resource set, the MAC entity assumes that the RA resource set is unavailable for RACH procedure.

An RA resource may be partitioned for each feature. The features may include at least one of Msg3 repetition, reduced capacity (RedCap), small data transmission (SDT), and RAN slicing.

In SIB1 transmitted by the base station, the following is notified.
Priority of each feature (priority, featurePriorities-r17) This priority is used to determine which FeatureCombinationPreambles are to be used by the UE when a given feature is mapped to more than one FeatureCombinationPreambles (feature combination preamble configuration).
Additional RO configuration The configuration includes an available feature (which may be associated with a plurality of features), an RA resource (for example, a preamble index), and a mask index for distinguishing an RO.

The UE determines, depending on the feature, an RO to be used.

SIB1 includes ServingCellConfigCommonSIB. It includes UplinkConfigCommonSIB. It includes BWP-UplinkCommon (UL BWP common configuration).

BWP-UplinkCommon may include a RACH common configuration (RACH-ConfigCommon or MsgA-ConfigCommon) and additionalRACH-ConfigList-r17 (additional RACH configuration list). additionalRACH-ConfigList-r17 may include rsrp-ThresholdMsg3-r17 (threshold).

The RACH common configuration may include FeatureCombinationPreambles. FeatureCombinationPreambles associates one set (partition) of preambles with one feature combination. FeatureCombinationPreambles may include FeatureCombination (feature combination configuration), startPreambleForThisPartition (index of first preamble), numberOfPreamblesPerSSB-ForThisPartition (number of preambles), and ssb-SharedRO-MaskIndex-r17 (PRACH mask index).

FeatureCombination includes at least one of redCap (RedCap), smallData (SDT), sliceGroup (RAN slicing), and msg3-Repetition (Msg3 repetition). The partition is given by the index of the first preamble and the number of preambles.

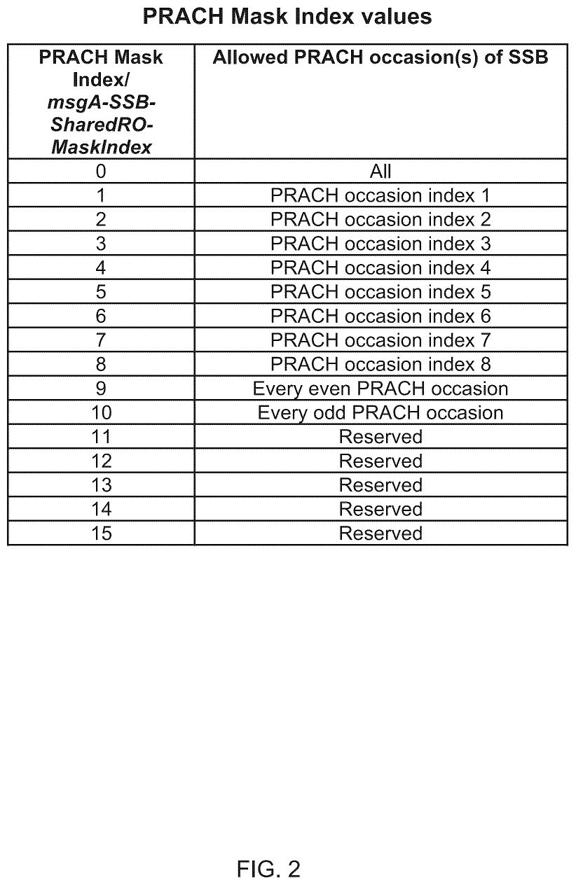

The PRACH mask index explicitly configures an available RO. FIG. 2 shows an example of a relationship between the PRACH mask index and an allowed PRACH occasion (RO) of an SSB (table of MAC protocol specifications/PRACH mask index values). At least one of PRACH occasion indices 1 to 8 can be configured.

The number of Msg3 repetitions is indicated by the 2 most significant bits (MSBs) (higher 2 bits) of a modulation and coding scheme (MCS) field in an RAR UL grant.

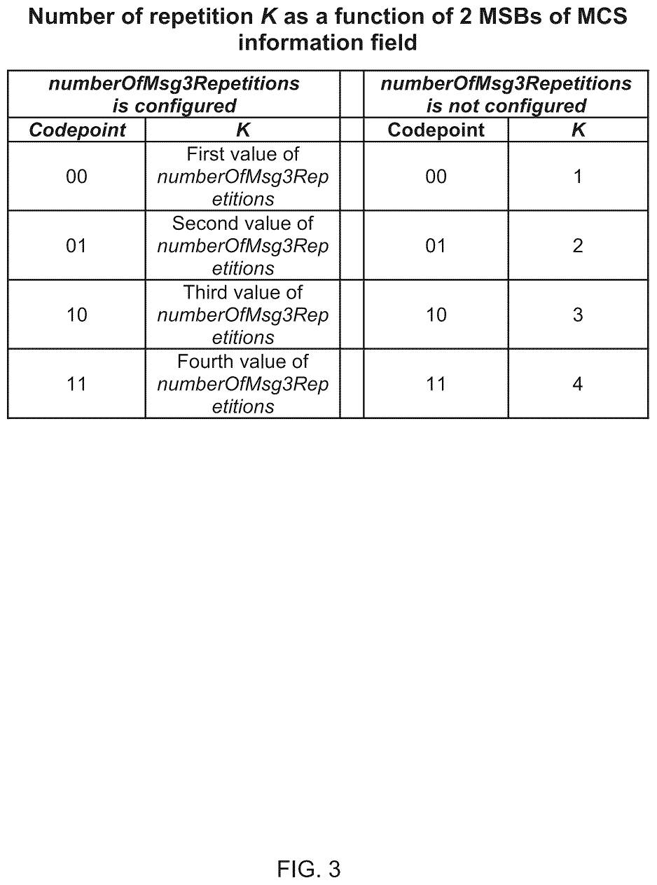

FIG. 3 shows an example of a relationship (table) between a value (codepoint) of the 2 MSBs of the MCS information field and the number K of repetitions. When a PUSCH scheduled by an RAR UL grant is transmitted in a PUSCH repetition type A, the 2 MSBs of the MCS information field in the RAR UL grant provides a codepoint for determination of the number K of repetitions, in accordance with the table in FIG. 3, based on whether a higher layer parameter “numberOfMsg3Repetitions” is configured. The number N of slots used to determine a transport block size (TBS) is equal to 1.

When a PUSCH scheduled by DCI format 0_0 with a CRC scrambled by a TC-RNTI is transmitted in a PUSCH repetition type B, the 2 MSBs of the MCS information field in the DCI format provides a codepoint for determination of the number K of repetitions, in accordance with the table in FIG. 3, based on whether a higher layer parameter “numberOfMsg3Repetitions” is configured. The number N of slots used to determine a TBS is equal to 1.

It is studied that a UE capability for Msg3 repetition is introduced to Rel. 17 and that a UE capability for Msg3 repetition is introduced to Rel. 18. Here, the following issues are conceivable.

### {Issue 1}

The issue is whether the UE reports these both capabilities, whether there is a relationship between these capabilities, whether two features for Msg1 repetition and Msg3 repetition operate together if the UE has these both capabilities, and the like.

### {Issue 2}

If these two features operate together, the issue is whether there is an impact on existing Msg3 repetition operation. For example, the issue is a beam for Msg3 repetition, the number of Msg3 repetitions, a relationship between Msg3 repetitions for respective Msgs3 corresponding to respective RARs, and the like. Case 1 where one RAR is transmitted for a plurality of Msg1 repetitions and case 2 where a plurality of RARs are transmitted for a plurality of Msg1 repetitions may be studied.

As described above, operation related to Msg1/3 repetition is indefinite. Unless such operation is definite, throughput reduction and the like may occur.

Hence, the inventors of the present invention came up with the idea of operation for repetition in random access procedure.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C.”

In the present disclosure, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

In the present disclosure, an SSB/CSI-RS index/indicator, a beam index, and a TCI state may be interchangeably interpreted.

### (Radio Communication Method)

In each embodiment, a RACH resource, an RA resource, a PRACH preamble, an occasion, a RACH occasion (RO), a PRACH occasion, a repetition resource, a repetition configuration resource, a resource configured for an RO/repetition, a time instance and a frequency instance, a time resource and a frequency resource, an RO/preamble resource, and repetition may be interchangeably interpreted. In each embodiment, a period, a periodicity, a frame, a subframe, a slot, a symbol, an occasion, and an RO may be interchangeably interpreted.

In each embodiment, a PDCCH order, PDCCH order DCI, DCI format 1_0, and message (Msg) 0 may be interchangeably interpreted. In each embodiment, a PRACH, a preamble, a PRACH preamble, a sequence, a preamble format, and Msg1 may be interchangeably interpreted. In each embodiment, a response to a PRACH, an RAR, Msg2, MsgB, Msg4, a base station response to BFR, and DCI for scheduling a response may be interchangeably interpreted. In each embodiment, transmission of a channel other than a PRACH in random access procedure, Msg3, a PUSCH scheduled by an RAR, a HARQ-ACK/PUCCH for Msg4, and a MsgA PUSCH may be interchangeably interpreted. In each embodiment, Msg3, a PUSCH scheduled by an RAR UL grant, and a RRC connection request may be interchangeably interpreted. In each embodiment, Msg4, contention resolution, RRC connection setup, and a PDSCH with a UE contention resolution identity may be interchangeably interpreted.

In each embodiment, a beam, an SSB, and an SSB index may be interchangeably interpreted. In each embodiment, a DL pathloss reference, a PL-RS, an SSB, and a CSI-RS may be interchangeably interpreted.

In each embodiment, a repetition period, a repetition configuration period, a repetition periodicity, and a repetition cycle may be interchangeably interpreted.

In each embodiment, random access (RA) procedure, CFRA/CBRA, a 4-step RACH/2-step RACH, random access procedure of a specific type, random access procedure using a specific PRACH format, random access procedure initiated by a PDCCH order, random access procedure not initiated by a PDCCH order, and random access procedure initiated by a higher layer may be interchangeably interpreted.

Each embodiment may assume Cases 1 and 2 below (Cases 1 and 2 described above).

### {Case 1}

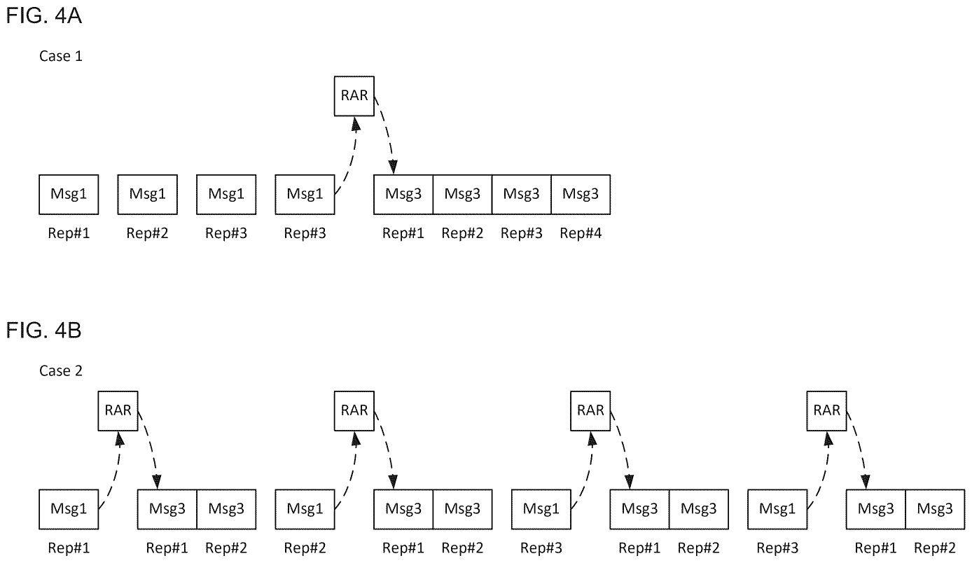

One RAR may be transmitted for a plurality of repetitions of a Msg1 (FIG. 4A).

### {Case 2}

One RAR may be transmitted for each of the plurality of repetitions of the Msg1 (FIG. 4B).

### Embodiment #1

A UE may transmit first capability information related to a capability for a repetition of a Msg1 and second capability information related to a capability for a repetition of a Msg3. The UE may determine, based on the first capability information and the second capability information, whether to perform first random access procedure including the repetition of the Msg1 and the repetition of the Msg3 or second random access procedure not including at least one of the repetition of the Msg1 and the repetition of the Msg3.

### Embodiment #1a

This embodiment relates to whether two features for Msg1 repetition and Msg3 repetition operate together.

### Embodiment #1a-1

Joint operation for Msg1 repetition and Msg3 repetition may not be supported.

As a type of a RACH resource, at least one type of the following several types may be present.
One or more sets of RACH resources for RACH procedure with neither Msg1 repetition nor Msg3 repetition
One or more sets of RACH resources for RACH procedure with Msg3 repetition and without Msg1 repetition
One or more sets of RACH resources for RACH procedure with Msg1 repetition and without Msg3 repetition

The numbers of Msg1/Msg3 repetitions may vary among a plurality of sets of RACH resources for RACH procedure with Msg1/Msg3 repetition.

### Example 1

“The UE does not assume simultaneous reporting of a capability for Msg1 repetition and a capability for Msg3 repetition” may be defined.

### Example 2

The UE that reports both of the capability for Msg1 repetition and the capability for Msg3 repetition may determine, based on a given condition, whether to perform only Msg1 repetition or only Msg3 repetition in one RACH procedure. For example, the condition may be a condition for RSRP of an SSB. In this case, the UE may follow at least one UE operation of the following several UE operations.

### UE Operation 1

When RSRP of a selected SSB is within a range 1, the UE judges that only Msg1 repetition is applied to subsequent RACH procedure. For example, the range 1 may be at least one of the RSRP being less than a threshold 1 and the RSRP being greater than a threshold 2.

### UE Operation 2

When the RSRP of the selected SSB is within a range 2, the UE judges that only Msg3 repetition is applied to the subsequent RACH procedure. For example, the range 2 may be at least one of the RSRP being less than a threshold 3 and the RSRP being greater than a threshold 4.

### UE Operation 3

When the RSRP of the selected SSB is within a range 3, the UE judges that neither Msg1 repetition nor Msg3 repetition is applied to the subsequent RACH procedure. For example, the range 3 may be the RSRP being greater than a threshold 5.
The range 1/2/3/threshold 1/2/3/4/5 may be defined in a specification, or may be indicated by a base station via a PBCH/SIB1 PDSCH/RRC IE.

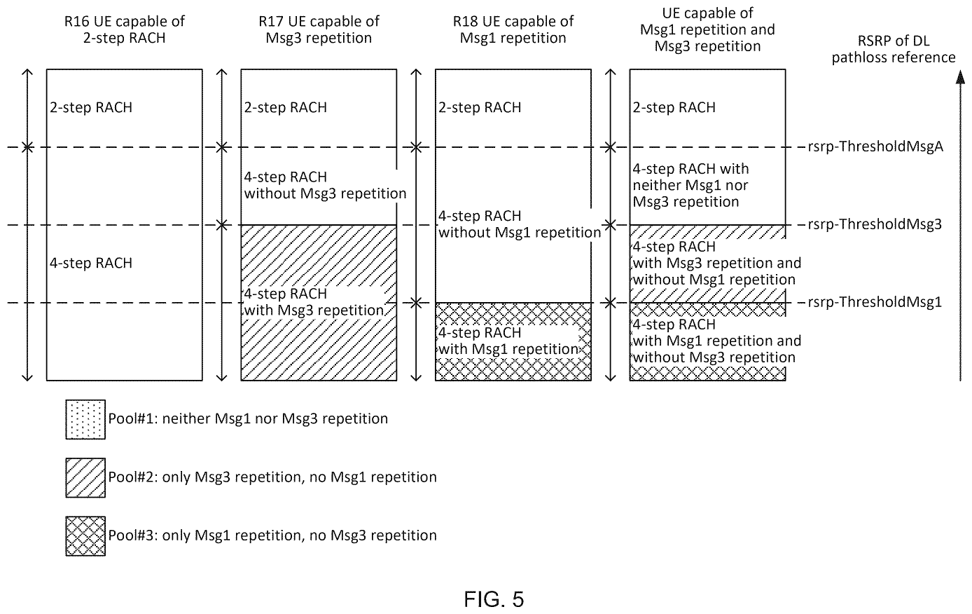

FIG. 5 shows an example of the RACH procedure for RSRP of a DL pathloss reference according to Embodiment #1a-1. The UE having a capability for a Rel-16 2-step RACH applies a 2-step RACH when the RSRP is rsrp-ThresholdMsgA or greater.

The UE having the capability for a Rel-16 2-step RACH applies a 4-step RACH when the RSRP is lower than rsrp-ThresholdMsgA. RA resources for the 2-step RACH and the 4-step RACH may be selected from pool #1.

The UE having a capability for Rel-17 Msg3 repetition applies a 4-step RACH without Msg3 repetition when the RSRP is a threshold “rsrp-ThresholdMsg3” or greater, and applies a 4-step RACH with Msg3 repetition when the RSRP is lower than the threshold “rsrp-ThresholdMsg3.” RA resources for the 2-step RACH and the 4-step RACH without Msg3 repetition may be selected from pool #1. RA resources for the 4-step RACH with Msg3 repetition may be selected from pool #2.

The UE having a capability for Rel-18 Msg1 repetition may apply a 4-step RACH without Msg1 repetition when the RSRP is a threshold “rsrp-ThresholdMsg1” or greater, and may apply a 4-step RACH with Msg1 repetition when the RSRP is lower than the threshold “rsrp-ThresholdMsg1.” RA resources for the 2-step RACH and the 4-step RACH without Msg1 repetition may be selected from pool #1. RA resources for the 4-step RACH with Msg1 repetition may be selected from pool #3.

The UE supporting Msg1 repetition and Msg3 repetition may apply a two-step RACH when the RSRP is rsrp-ThresholdMsgA or greater. When the RSRP is lower than rsrp-ThresholdMsgA and is the threshold “rsrp-ThresholdMsg3” or greater, the UE may apply a 4-step RACH with neither Msg1 repetition nor Msg3 repetition. When the RSRP is lower than rsrp-ThresholdMsg3 and is the threshold “rsrp-ThresholdMsg1” or greater, the UE may apply a 4-step RACH with Msg3 repetition and without Msg1 repetition. When the RSRP is lower than the threshold “rsrp-ThresholdMsg1,” the UE may apply a 4-step RACH with Msg1 repetition and without Msg3 repetition. RA resources for the 2-step RACH and the 4-step RACH with neither Msg1 repetition nor Msg3 repetition may be selected from pool #1. RA resources for the 4-step RACH with Msg3 repetition and without Msg1 repetition may be selected from pool #2. RA resources for the 4-step RACH with Msg1 repetition and without Msg3 repetition may be selected from pool #3.

### Embodiment #1a-2

The joint operation for Msg1 repetition and Msg3 repetition may be supported.

As a type of a RACH resource, at least one type of the following several types may be present.
One or more sets of RACH resources for RACH procedure with neither Msg1 repetition nor Msg3 repetition
One or more sets of RACH resources for RACH procedure with Msg3 repetition and without Msg1 repetition
One or more sets of RACH resources for RACH procedure with Msg1 repetition and without Msg3 repetition
One or more sets of RACH resources for RACH procedure with both Msg1 repetition and Msg3 repetition

The numbers of Msg1/Msg3 repetitions may vary among a plurality of sets of RACH resources for RACH procedure with Msg1/Msg3 repetition.

If the UE reports both of the capability for Msg1 repetition and the capability for Msg3 repetition, UE operation may be based on a given condition. For example, the condition may be a condition for RSRP of an SSB.

### Example 1

At least one of the following several UE operations may be applicable to Msg1/Msg3 repetition. Each UE operation may correspond to a range of SSB RSRP.

### UE Operation 1

In the subsequent RACH procedure, neither Msg1 repetition nor Msg3 repetition is applied. The condition may be at least one of the SSB RSRP being a threshold 1 or greater and the SSB RSRP being lower than a threshold 2. The threshold 1 may be rsrp-Threshold-NoRep.

### UE Operation 2

In the subsequent RACH procedure, only Msg3 repetition is applied. The condition may be at least one of the SSB RSRP being a threshold 3 or greater and the SSB RSRP being lower than a threshold 4. The threshold 3 may be rsrp-Threshold-NoRep. The threshold 4 may be rsrp-ThresholdMsg3.

### UE Operation 3

In the subsequent RACH procedure, both Msg1 repetition and Msg3 repetition are applied. The condition may be at least one of the SSB RSRP being a threshold 5 or greater and the SSB RSRP being lower than a threshold 6. The threshold 6 may be rsrp-ThresholdMsg1.

The threshold 1/2/3/5/6 may be defined in a specification, or may be indicated by the base station via a PBCH/SIB1 PDSCH/RRC IE.

### Example 2

At least one of the following several UE operations may be applicable to Msg1/Msg3 repetition. Each UE operation may correspond to a range of SSB RSRP. {{UE Operation 1}}

In the subsequent RACH procedure, neither Msg1 repetition nor Msg3 repetition is applied. The condition may be at least one of the SSB RSRP being a threshold 1 or greater and the SSB RSRP being lower than a threshold 2. The threshold 1 may be rsrp-ThresholdMsg3.

### UE Operation 2

In the subsequent RACH procedure, only Msg3 repetition is applied. The condition may be at least one of the SSB RSRP being a threshold 5 or greater and the SSB RSRP being lower than a threshold 6. The threshold 5 may be rsrp-ThresholdMsg1. The threshold 6 may be rsrp-ThresholdMsg3.

### UE Operation 3

In the subsequent RACH procedure, only Msg1 repetition is applied. The condition may be at least one of the SSB RSRP being a threshold 3 or greater and the SSB RSRP being lower than a threshold 4. The threshold 3 may be rsrp-ThresholdMsg3. The threshold 4 may be rsrp-ThresholdMsg1.

### UE Operation 4

In the subsequent RACH procedure, both Msg1 repetition and Msg3 repetition are applied. The condition may be at least one of the SSB RSRP being a threshold 7 or greater and the SSB RSRP being lower than a threshold 8. The threshold 8 may be rsrp-ThresholdMsg1Msg3.

The threshold 1/2/3/4/5/6/7/8 may be defined in a specification, or may be indicated by the base station via a PBCH/SIB1 PDSCH/RRC IE.

According to a coverage evaluation result in Rel-17 coverage enhancement (CovEnh), a Msg3 serves as a bottleneck more than a Msg1 does. Accordingly, it is preferable that when Msg1 repetition is required, Msg3 repetition is also required. Therefore, Example 1 is more preferable than Example 2.

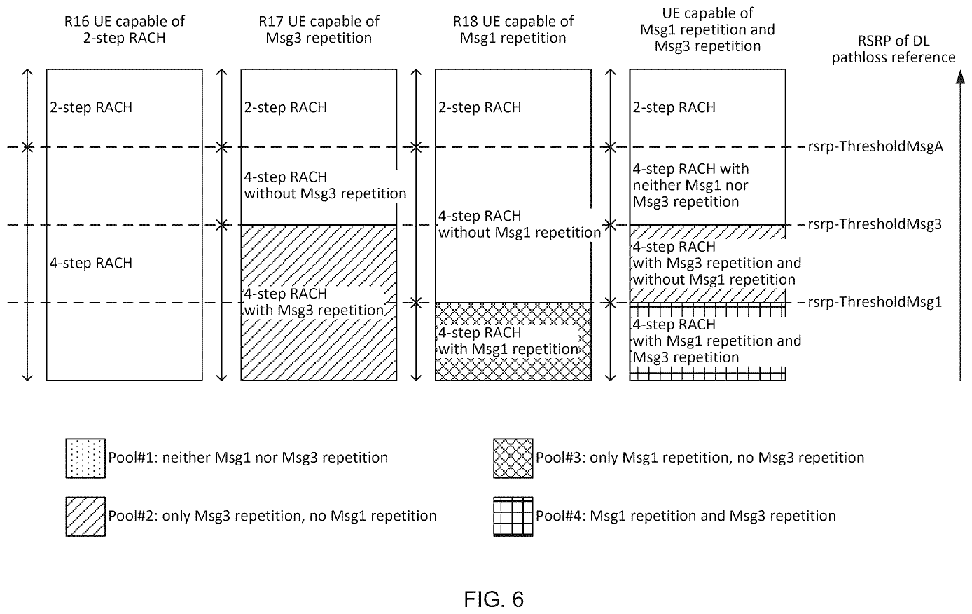

FIG. 6 shows an example of the RACH procedure for RSRP of a DL pathloss reference according to Example 1 of Embodiment #1a-2. The UE having the capability for a Rel-16 2-step RACH, the UE having the capability for Rel-17 Msg3 repetition, and the UE having the capability for Rel-18 Msg1 repetition perform the same operation as that described in Embodiment #1a-1.

The UE supporting Msg1 repetition and Msg3 repetition may apply a two-step RACH when the RSRP is rsrp-ThresholdMsgA or greater. When the RSRP is lower than rsrp-ThresholdMsgA and is the threshold “rsrp-ThresholdMsg3” or greater, the UE may apply a 4-step RACH with neither Msg1 repetition nor Msg3 repetition. When the RSRP is lower than rsrp-ThresholdMsg3 and is the threshold “rsrp-ThresholdMsg1” or greater, the UE may apply a 4-step RACH with Msg3 repetition and without Msg1 repetition. When the RSRP is lower than the threshold “rsrp-ThresholdMsg1,” the UE may apply a 4-step RACH with Msg1 repetition and Msg3 repetition. RA resources for the 2-step RACH and the 4-step RACH with neither Msg1 repetition nor Msg3 repetition may be selected from pool #1. RA resources for the 4-step RACH with Msg3 repetition and without Msg1 repetition may be selected from pool #2. RA resources for the 4-step RACH with Msg1 repetition and Msg3 repetition may be selected from pool #3.

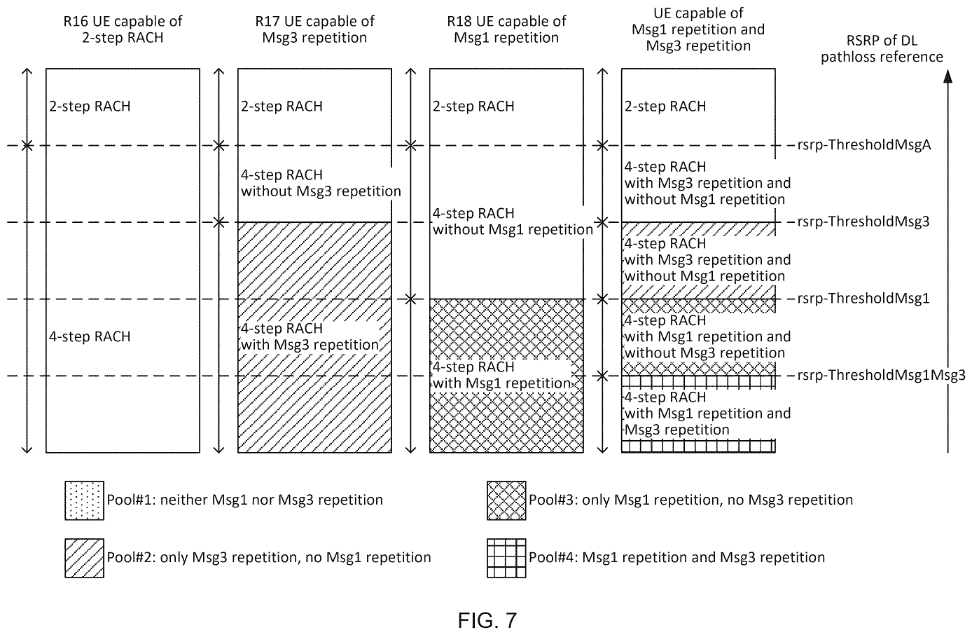

FIG. 7 shows an example of the RACH procedure for RSRP of a DL pathloss reference according to Example 2 of Embodiment #1a-2. The UE having the capability for a Rel-16 2-step RACH, the UE having the capability for Rel-17 Msg3 repetition, and the UE having the capability for Rel-18 Msg1 repetition perform the same operation as that described in Embodiment #1a-1.

The UE supporting Msg1 repetition and Msg3 repetition may apply a two-step RACH when the RSRP is rsrp-ThresholdMsgA or greater. When the RSRP is lower than rsrp-ThresholdMsgA and is the threshold “rsrp-ThresholdMsg3” or greater, the UE may apply a 4-step RACH with neither Msg1 repetition nor Msg3 repetition. When the RSRP is lower than rsrp-ThresholdMsg3 and is the threshold “rsrp-ThresholdMsg1” or greater, the UE may apply a 4-step RACH with Msg3 repetition and without Msg1 repetition. When the RSRP is lower than rsrp-ThresholdMsg1 and is the threshold “rsrp-ThresholdMsg1Msg3” or greater, the UE may apply a 4-step RACH with Msg1 repetition and without Msg3 repetition. When the RSRP is lower than the threshold “rsrp-ThresholdMsg1Msg3,” the UE may apply a 4-step RACH with Msg1 repetition and Msg3 repetition. RA resources for the 2-step RACH and the 4-step RACH with neither Msg1 repetition nor Msg3 repetition may be selected from pool #1. RA resources for the 4-step RACH with Msg3 repetition and without Msg1 repetition may be selected from pool #2. RA resources for the 4-step RACH with Msg1 repetition and without Msg3 repetition may be selected from pool #3. RA resources for the 4-step RACH with Msg1 repetition and Msg3 repetition may be selected from pool #4.

<<Embodiment #1a-3>>

The joint operation for Msg1 repetition and Msg3 repetition may be supported, and the capability for Msg3 repetition may be a prerequisite capability (requirement) for the capability for Msg1 repetition.

The UE that reports the capability for Msg1 repetition may be defined to have the capability for Msg3 repetition.

As a type of a RACH resource, at least one type of the following several types may be present.
One or more sets of RACH resources for RACH procedure with neither Msg1 repetition nor Msg3 repetition
One or more sets of RACH resources for RACH procedure with Msg3 repetition and without Msg1 repetition
One or more sets of RACH resources for RACH procedure with both Msg1 repetition and Msg3 repetition

The numbers of Msg1/Msg3 repetitions may vary among a plurality of sets of RACH resources for RACH procedure with Msg1/Msg3 repetition.

If the UE reports both of the capability for Msg1 repetition and the capability for Msg3 repetition, UE operation may be based on a given condition. For example, the condition may be a condition for RSRP of an SSB.

At least one of the following several UE operations may be applicable to Msg1/Msg3 repetition. Each UE operation may correspond to a range of SSB RSRP.

### UE Operation 1

In the subsequent RACH procedure, neither Msg1 repetition nor Msg3 repetition is applied. The condition may be at least one of the SSB RSRP being a threshold 1 or greater and the SSB RSRP being lower than a threshold 2. The threshold 1 may be rsrp-Threshold-NoRep.

### UE Operation 2

In the subsequent RACH procedure, only Msg3 repetition is applied. The condition may be at least one of the SSB RSRP being a threshold 3 or greater and the SSB RSRP being lower than a threshold 4. The threshold 3 may be rsrp-Threshold-NoRep. The threshold 4 may be rsrp-ThresholdMsg3.

### UE Operation 3

In the subsequent RACH procedure, both Msg1 repetition and Msg3 repetition are applied. The condition may be at least one of the SSB RSRP being a threshold 5 or greater and the SSB RSRP being lower than a threshold 6. The threshold 6 may be rsrp-ThresholdMsg1.

The threshold 1/2/3/5/6 may be defined in a specification, or may be indicated by the base station via a PBCH/SIB1 PDSCH/RRC IE.

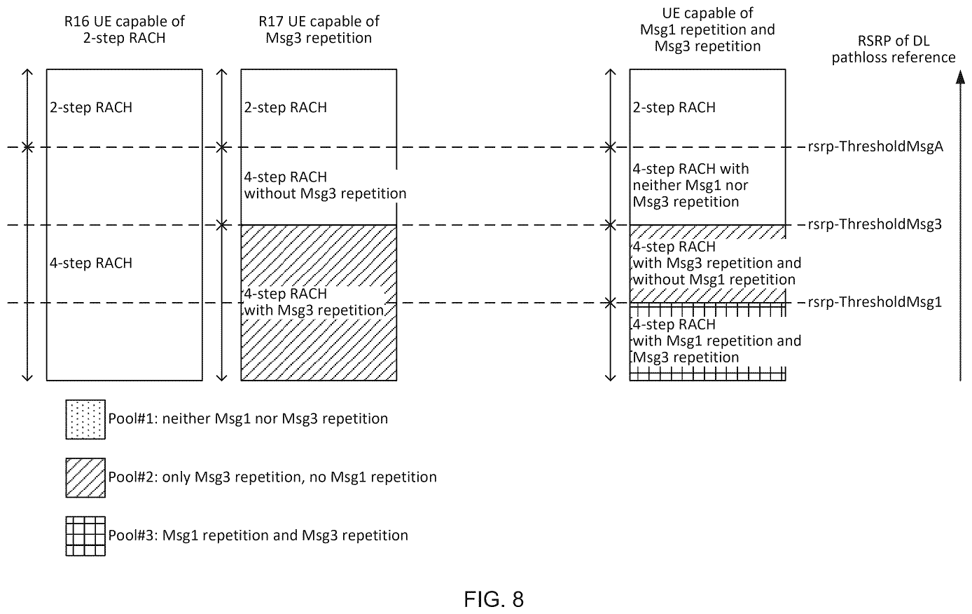

FIG. 8 shows an example of the RACH procedure for RSRP of a DL pathloss reference according to Embodiment #1a-3. The UE having the capability for a Rel-16 2-step RACH and the UE having the capability for Rel-17 Msg3 repetition perform the same operation as that described in Embodiment #1a-1.

The UE supporting Msg1 repetition and Msg3 repetition may apply a two-step RACH when the RSRP is rsrp-ThresholdMsgA or greater. When the RSRP is lower than rsrp-ThresholdMsgA and is the threshold “rsrp-ThresholdMsg3” or greater, the UE may apply a 4-step RACH with neither Msg1 repetition nor Msg3 repetition. When the RSRP is lower than rsrp-ThresholdMsg3 and is the threshold “rsrp-ThresholdMsg1” or greater, the UE may apply a 4-step RACH with Msg3 repetition and without Msg1 repetition. When the RSRP is lower than the threshold “rsrp-ThresholdMsg1,” the UE may apply a 4-step RACH with Msg1 repetition and Msg3 repetition. RA resources for the 2-step RACH and the 4-step RACH with neither Msg1 repetition nor Msg3 repetition may be selected from pool #1. RA resources for the 4-step RACH with Msg3 repetition and without Msg1 repetition may be selected from pool #2. RA resources for the 4-step RACH with Msg1 repetition and Msg3 repetition may be selected from pool #3.

### Embodiment #1a-4

Some of Embodiments #1a-1 to #1a-3 may be combined with each other. In a case where at least one application condition of the following several application conditions is satisfied, Embodiment #1a-2/ #1a-3 may be applied.

### Application Condition 1

For a case where one RAR is transmitted for a plurality of Msg1 repetitions, joint operation for Msg1 repetition and Msg3 repetition in one RACH procedure may be supported.

### Application Condition 2

For a case where a plurality of RARs are transmitted for a plurality of Msg1 repetitions, joint operation for Msg1 repetition and Msg3 repetition in one RACH procedure may be supported.

### Application Condition 3

For a case where the same transmission beam is used for a plurality of Msg1 repetitions, joint operation for Msg1 repetition and Msg3 repetition in one RACH procedure may be supported.

### Application Condition 4

For a case where different transmission beams are used for a plurality of Msg1 repetitions, joint operation for Msg1 repetition and Msg3 repetition in one RACH procedure may be supported.

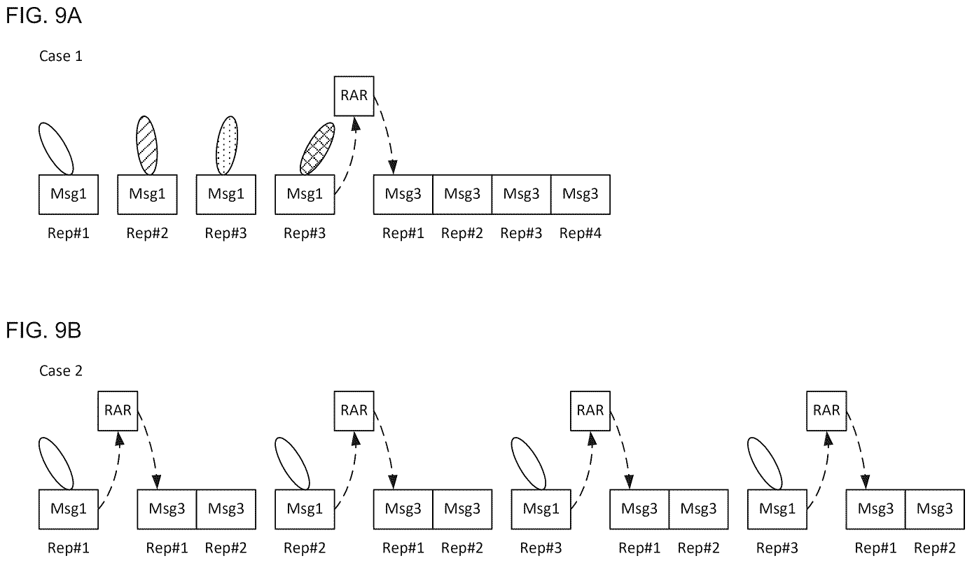

In an example in FIG. 9A, the application condition is Application Condition 1 and Application Condition 4. In an example in FIG. 9B, the application condition is Application Condition 2 and Application Condition 3.

According to this embodiment, the UE can appropriately determine Msg1/Msg3 repetition.

### Embodiment #1b

There is a tradeoff between the number of PRACH repetitions and the number of PRACH resources. It is preferable for a base station to be able to control at least one of whether PRACH repetition is performed and a maximum number of PRACH repetitions.

The UE may receive a configuration/indication related to information related to whether to perform PRACH repetition.

### Embodiment #1b-1

The information related to whether to perform PRACH repetition may be at least one of the following several pieces of information.

### Information 1

The information indicates whether a PRACH repetition feature is turned on or off. The information may be implicitly indicated based on another configuration. For example, an RO/RA resource configuration may implicitly indicate whether PRACH repetition is turned on or off. For example, whether a configuration related to an RSRP threshold is present may implicitly indicate whether PRACH repetition is turned on or off.

### Information 2

The information indicates the number of PRACH repetitions. Candidate values of the number may include at least one of {1, 2, 4, 8, 16, 32}. A value of 1 may be equivalent to turning off PRACH repetition.

### Information 3

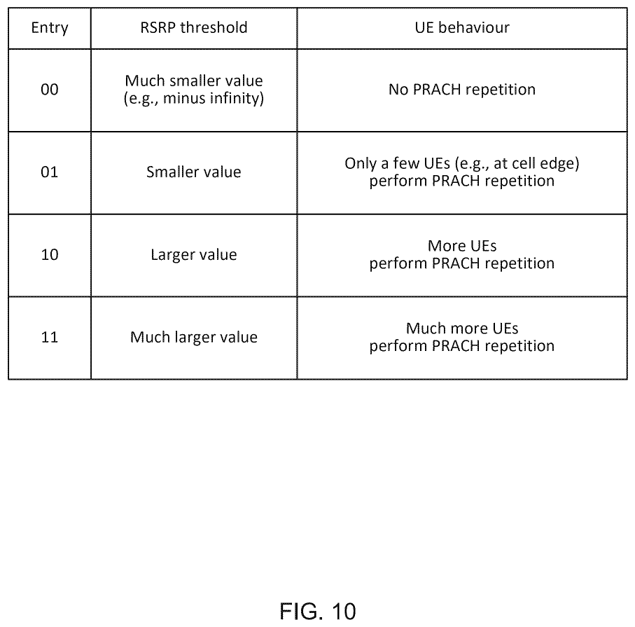

The information may be an RSRP threshold. As described in an example in FIG. 10, the RSRP threshold for determining whether to perform PRACH repetition may be defined for each entry. For example, when the RSRP threshold is a much smaller value (for example,−”), UE operation may be a case that no PRACH repetition is performed. For example, when the RSRP threshold is a smaller value, the UE operation may be a case that fewer UEs perform PRACH repetition. For example, when the RSRP threshold is a larger value, the UE operation may be a case that more UEs perform PRACH repetition. For example, when the RSRP threshold is a much larger value, the UE operation may be a case that much more UEs perform PRACH repetition. The RSRP threshold may be defined in a specification, may be configured by RRC, or may be indicated via a MAC CE/DCI.

### Embodiment #1b-2

The information related to whether to perform PRACH repetition may be configured/indicated by at least one of the following several configuration/indication methods.

### Configuration/Indication Method 1

The information is configured via an SIB1 PDSCH.

### Configuration/Indication Method 2

The information is configured via an REC IE.

### Configuration/Indication Method 3

The information is indicated via a MAC CE.

### Configuration/Indication Method 4

The information is indicated via DCI.

A combination of these several configuration/indication methods may be supported. For example, the information being configured via the SIB1 PDSCH and the RRC IE may be supported.

Bit widths for configurations/indications may vary among different configuration/indication methods. For example, one bit may be used in Configuration/Indication Method 1, and two bits may be used in Configuration/Indication Method 2.

It is preferable that at least Configuration/Indication

Method 1 is supported to support PRACH repetition during initial access.

### Embodiment #1b-3

The configuration/indication of the information related to whether to perform PRACH repetition may require that at least one requirement of the following several requirements is satisfied.

### Requirement 1

Msg3 repetition is supported.

### Requirement 2

An RO/RA resource in which Msg3 repetition is available is configured.

### Requirement 3

Msg1 repetition is supported.

### Requirement 4

An RO/RA resource in which Msg1 repetition is available is configured.

According to this embodiment, the UE can appropriately determine Msg1/Msg3 repetition.

### Embodiment #X

This embodiment relates to a RACH resource.

The UE may receive information related to first random access procedure including a repetition of a Msg1. Based on the information, the UE may use a first random access resource for the first random access procedure and may use a second random access resource different from the first random access resource for second random access procedure not including the repetition of the Msg1.

### Embodiment #Xa

PRACH repetition may be performed only in a specific RA resource.

### Embodiment #Xa-1

The specific RA resource may be at least one of the following several RA resources.

{RA Resource 1} An RA resource in which a feature for at least Msg3 repetition is available. {RA Resource 2} An RA resource in which a feature for neither Msg3 repetition, RedCap, RAN Slicing, nor SDT is available. {RA Resource 3} An RA resource in which a feature for at least PRACH repetition is available. In this case, a feature for PRACH repetition is introduced.

{RA Resource 4} Several combinations of RA Resources 1 to 3. RA Resource 1+RA Resource 3 or RA Resource 2+RA Resource 3.

### Embodiment #Xa-2

PRACH (Msg1) repetition may follow at least one of the following several PRACH repetition definitions.

{PRACH Repetition Definition 1} A plurality of PRACH transmissions with the same beam.

{PRACH Repetition Definition 2} A plurality of PRACH transmissions with different beams.

{PRACH Repetition Definition 3} A plurality of PRACH transmissions (with the same beam or different beams) before expiration of an RAR window.

{PRACH Repetition Definition 4} A plurality of PRACH transmissions including the first PRACH transmission. {PRACH Repetition Definition 5} A plurality of PRACH transmissions not including the first PRACH transmission. In this case, the first PRACH transmission may be transmitted in the same RA resource as an RA resource for PRACH transmission in Rel. 15/16. Subsequent PRACH transmission(s) may be transmitted in the RA resource in Embodiment #Xa-1.

The RA resource, a PRACH preamble, and a PRACH preamble index may be interchangeably interpreted.

<<<<Embodiment #Xa-3>>>>

An RA resource for PRACH repetition may follow at least one of the following several partition methods.

{Partition Method 1}

It may be assumed that RA Resource 1 described above is applied. For an RA resource in which at least Msg3 repetition is available, at least one of the following several RA resource configurations may be configured.

{{RA Resource Configuration 1-1}} The number of preamble indices available for PRACH repetition.

When only the configuration of the number of preamble indices is present, the first preamble index available for PRACH repetition may be determined for each specific rule. For example, the first preamble index may be the first preamble index for which Msg3 repetition is configured. All the available preamble indices for which PRACH repetition is configured may be accommodated in preamble indices starting from the determined preamble index, the preamble indices being applicable to Msg3 repetition. {{RA Resource Configuration 1-2}} The first preamble index available for PRACH repetition.

When only the configuration of the first preamble index is present, a total number of preamble indices available for PRACH repetition may be determined for each specific rule. For example, the total number may be the number of all the preamble indices for which Msg3 repetition is configured, the preamble indices starting from the configured first preamble index.

### Partition Method 2

It may be assumed that RA Resource 2 described above is applied. The RA resource for PRACH repetition may be an RA resource other than the RA resource in which neither of the features for Msg3 repetition, RedCap, RAN slicing, and SDT is available.

### Partition Method 3

It may be assumed that RA Resource 3 described above is applied. For an RA resource in which at least Msg3 repetition is available, at least one of the following several RA resource configurations may be configured. {{RA Resource Configuration 3-1}} The first preamble index available for PRACH repetition.

{{RA Resource Configuration 3-2}} The number of preamble indices available for PRACH repetition.

As with Embodiment #Xa-1, several combinations of Partition Methods 1 to 3 may be considered.

<Embodiment #Xb>

PRACH repetition may be performed only in a specific RACH occasion (RO).

### Embodiment #Xb-1

The specific RO may be at least one of the following several ROS.

{RO1} An RO in which a feature for at least Msg3 repetition is available.

{RO2} An RO in which a feature for neither Msg3 repetition, RedCap, RAN Slicing, nor SDT is available.

{RO3} An RO in which a feature for at least PRACH repetition is available. In this case, a feature for PRACH repetition is introduced.

{RO4} Several combinations of ROs 1 to 3. RO1+RO3 or RO2+RO3.

### Embodiment #Xb-2

PRACH repetition may follow at least one of the following several PRACH repetition definitions.

{PRACH Repetition Definition 1} A plurality of PRACH transmissions with the same beam.

{PRACH Repetition Definition 2} A plurality of PRACH transmissions with different beams.

{PRACH Repetition Definition 3} A plurality of PRACH transmissions (with the same beam or different beams) before expiration of an RAR window.

{PRACH Repetition Definition 4} A plurality of PRACH transmissions including the first PRACH transmission.

{PRACH Repetition Definition 5} A plurality of PRACH transmissions not including the first PRACH transmission. In this case, the first PRACH transmission may be transmitted in the same RA resource as an RA resource for PRACH transmission in Rel. 15/16. Subsequent PRACH transmission(s) may be transmitted in the RO in

### Embodiment #Xb-1

### <<<<Embodiment #Xb-3>>>>

An RO for PRACH repetition may follow at least one of the following several partition methods.

### Partition Method 1

It may be assumed that RO1 described above is applied. To determine an RO available for the PRACH repetition, an explicit configuration for configuring determination of an RO for at least Msg3 repetition may be considered.

### Partition Method 2

It may be assumed that RO2 described above is applied. To determine an RO available for the PRACH repetition, an RO not configured by a corresponding mask index with another feature may be considered.

### Partition Method 3

It may be assumed that RO3 described above is applied. To determine an RO available for the PRACH repetition, an explicit configuration for configuring determination of an RO for at least PRACH repetition may be considered.

As with Embodiment #Xb-1, several combinations of Partition Methods 1 to 3 may be considered.

### Embodiment #Xb-4

Restriction/enhancement of a mask index may follow at least one of the following several restrictions/enhancements.

### Restriction/Enhancement 1

A PRACH mask index configured for PRACH repetition is different from a PRACH mask index configured for another feature/usage. The feature/usage may include at least one of the following several feature/usages.
Msg3 repetition
RedCap
SDT
RAN slicing
2-step RA
Absence (that is, existing 4-step RA)

### Restriction/Enhancement 2

An available PRACH mask index entry may be enhanced based on at least one of the following several enhancement methods. {{Enhancement Method 1}} Adding an entry for a PRACH occasion index X. Here, X may be an integer greater than 8. {{Enhancement Method 2}} Adding an entry for the first/second/third/ . . . /X-th PRACH occasion of X PRACH occasions. Here, X may be an integer greater than 2. For example, X may be 3, 4, or 5.

### Restriction/Enhancement 3

A bit width for PRACH mask index configuration may be enhanced to cover more than 16 entries.

According to this embodiment, the UE can appropriately determine a RACH resource for PRACH repetition.

### Embodiment #2

This embodiment relates to joint operation for Msg1 repetition and Msg3 repetition.

The UE may receive information related to random access procedure including a plurality of repetitions of a Msg1 and a plurality of repetitions of a Msg3. Based on the information, the UE may determine one or more second beams to be used for the plurality of repetitions of the Msg3, based on one or more first beams to be used for the plurality of repetitions of the Msg1.

### Case 1

A case where one RAR is transmitted for a plurality of Msg1 repetitions in joint operation for Msg1 repetition with Msg3 repetition in one RACH procedure.

A transmission beam for the Msg3 repetition may depend on a beam for at least one of the Msg1 repetition and a detected RAR.

The transmission beam for the Msg3 repetition may be any one of the following several transmission beams.

### {Transmission Beam 1-1}

The same beam may be used for all the Msg3 repetitions.

### {{Transmission Beam 1-1A}}

The same beam for all the Msg3 repetitions may be determined based on a beam for Msg1 repetition.

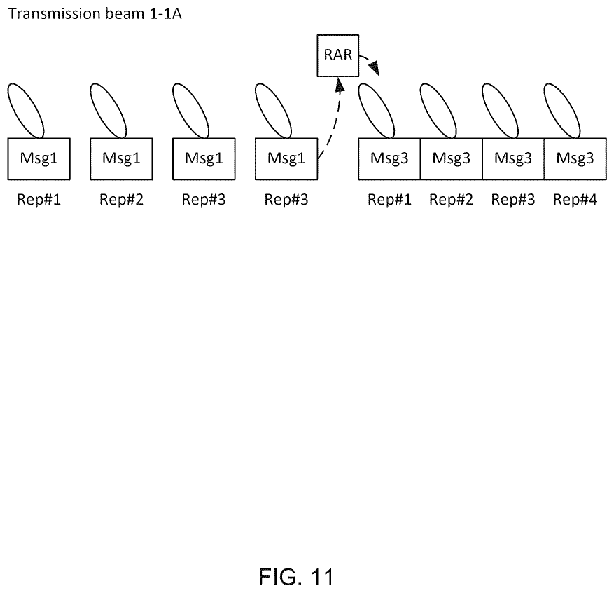

Example: if a plurality of Msg1 repetitions use the same beam, a beam for Msg3 repetitions may be the same as the beam for the Msg1 repetition (FIG. 11).

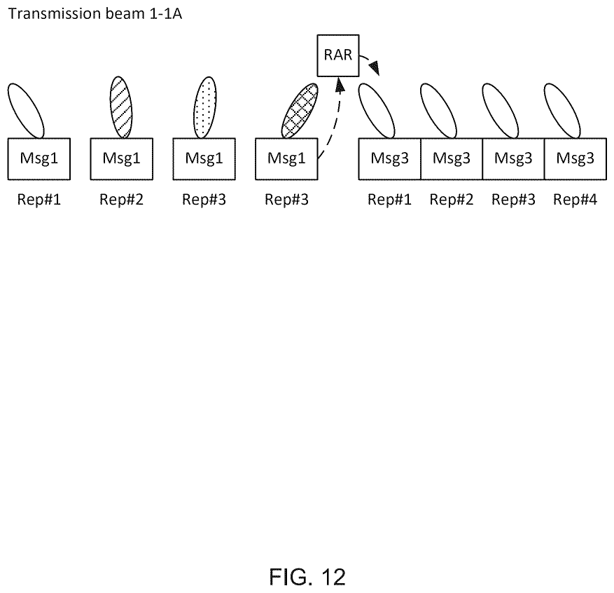

Example: if a plurality of Msg1 repetitions use different beams, a beam for Msg3 repetitions may follow a beam for the first/last/any Msg1 repetition. In an example in FIG. 12, four Msg3 repetitions use a beam used for the first repetition of four Msg1 repetitions.

### {{Transmission Beam 1-1B}}

The same beam for all the Msg3 repetitions may be determined based on a detected RAR.

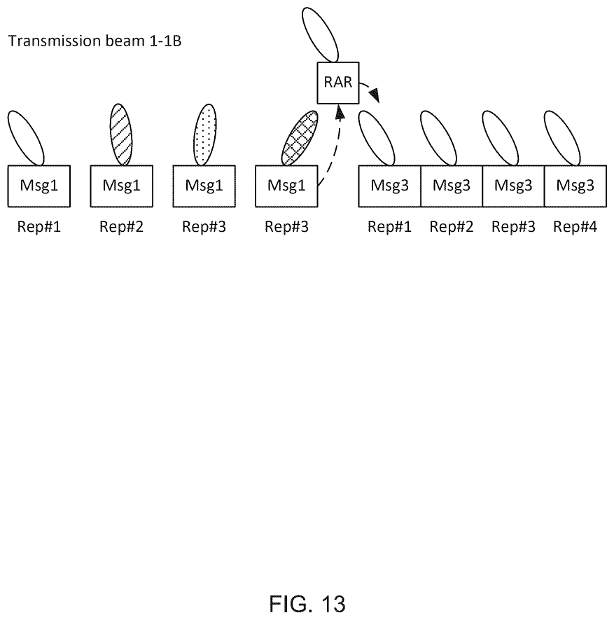

Example: the beam may be determined by an explicit indication in the RAR. One field in the RAR may indicate a beam for the Msg3 repetitions. “The UE assumes that the indicated beam is obtained from a beam for Msg1 repetition” may be defined. In an example in FIG. 13, an RAR indicates a beam to be used for four Msg3 repetitions. The beam is a beam used for one of four Msg1 repetitions.

Example: the beam may be determined by an implicit indication, such as an RA-RNTI. For example, the beam may be determined based on an RO corresponding to an RA-RNTI used for a detected RAR.

### {Transmission Beam 1-2}

Different beams may be used for all the Msg3 repetitions.

### {{Transmission Beam 1-2A}}

A beam for a plurality of Msg3 repetitions may be determined based on a beam for Msg1 repetition. If a plurality of Msg1 repetitions use different beams, a beam for a plurality of Msg3 repetitions may follow beams for the plurality of Msg1 repetitions.

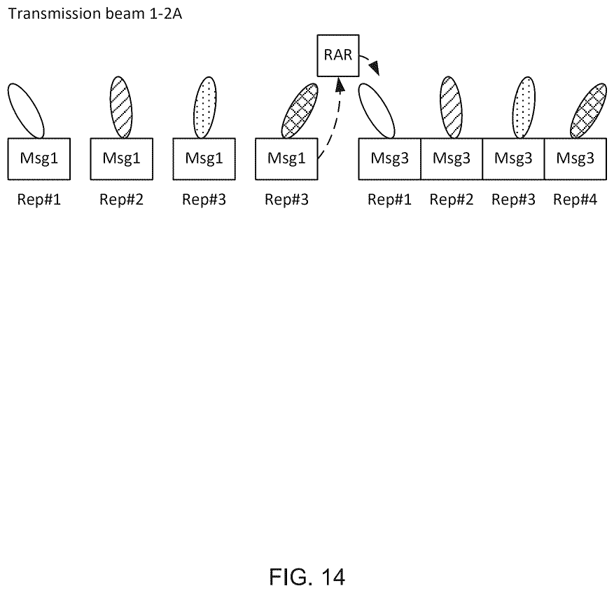

Example: if the number of Msg1 repetitions is equal to the number of Msg3 repetitions, mapping between beams for a plurality of Msg1 repetitions and beams for a plurality of Msg3 repetitions may be one-to-one mapping. In an example in FIG. 14, four beams used for four Msg3 repetitions are four beams used for four Msg1 repetitions.

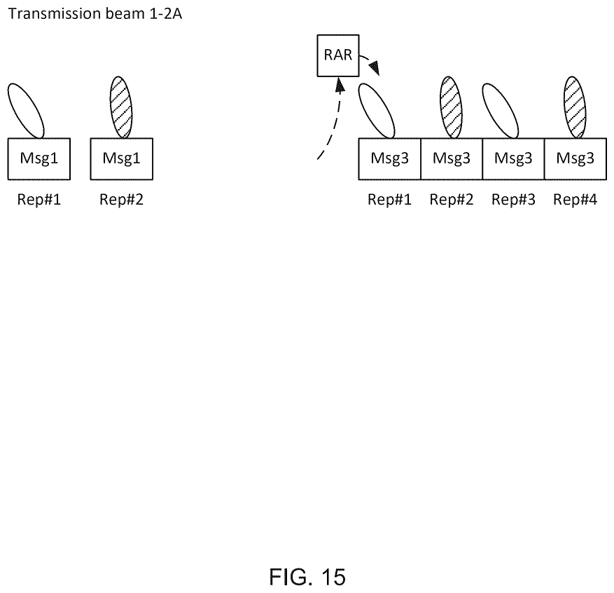

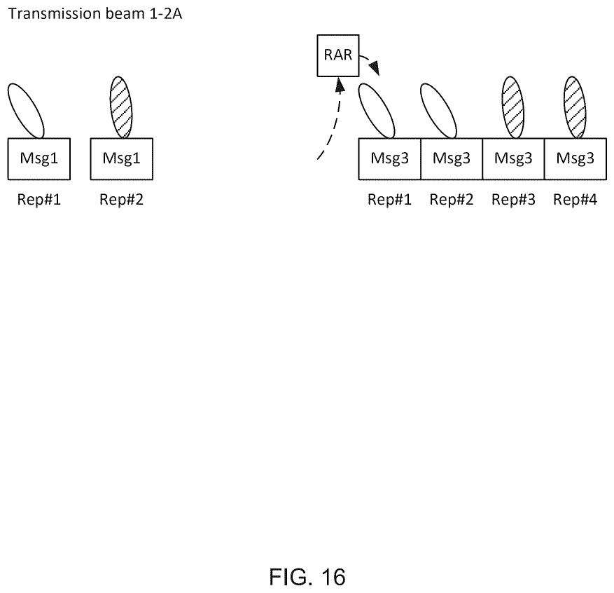

Example: if the number of Msg1 repetitions is less than the number of Msg3 repetitions, mapping between beams for a plurality of Msg1 repetitions and beams for a plurality of Msg3 repetitions may be sequential mapping or cyclic mapping. In an example in FIG. 15, two beams used for two Msg1 repetitions are cyclically applied to four beams used for four Msg3 repetitions (cyclic mapping). In an example in FIG. 16, respective beams used for two Msg1 repetitions are each applied twice sequentially to four beams used for four Msg3 repetitions (sequential mapping).

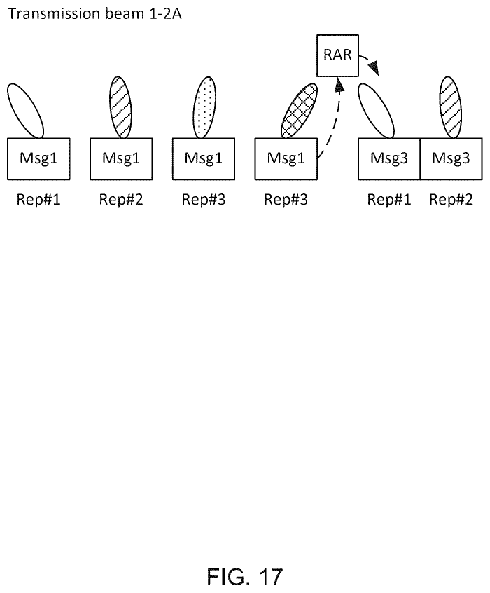

Example: if the number of Msg1 repetitions is greater than the number N of Msg3 repetitions, beams for N Msg3 repetitions may be beams for the first/last/any N Msg1 repetitions. In an example in FIG. 17, two beams used for two Msg3 repetitions are two beams used for the first two repetitions of four Msg1 repetitions.

### {{Transmission Beam 1-2B}}

A beam for a plurality of Msg3 repetitions may be determined based on a detected RAR.

Example: the beam may be determined by an explicit indication in the RAR. “The UE assumes that the indicated beam is obtained from a beam for Msg1 repetition” may be defined.

### <<Case 2>>

A case where a plurality of RARs are transmitted for a plurality of Msg1 repetitions in joint operation for Msg1 repetition with Msg3 repetition in one RACH procedure.

In each Msg3 scheduled by each RAR, a beam for a plurality of repetitions of the Msg3 may depend on a beam for at least one of a corresponding Msg1 repetition, a corresponding RAR, and a beam for all the Msg1 repetitions.

The UE may follow at least one of the following several operations.
The UE does not assume different numbers of repetitions for a plurality of Msg3 PUSCHs.
The UE does not assume that the sum of the numbers of repetitions for the plurality of Msg3 PUSCHs exceeds a given value.
The UE does not assume that any repetition of a previous Msg3 PUSCH collides with any repetition of a subsequent Msg3 PUSCH.
The UE does not assume that any repetition of a previous Msg3 PUSCH starts/ends after any repetition of a subsequent Msg3 PUSCH.

The transmission beam for the Msg3 repetition may be any one of the following several transmission beams.

### {Transmission Beam 2-1}

The same beam may be used for all the Msg3 repetitions.

### {{Transmission Beam 2-1A}}

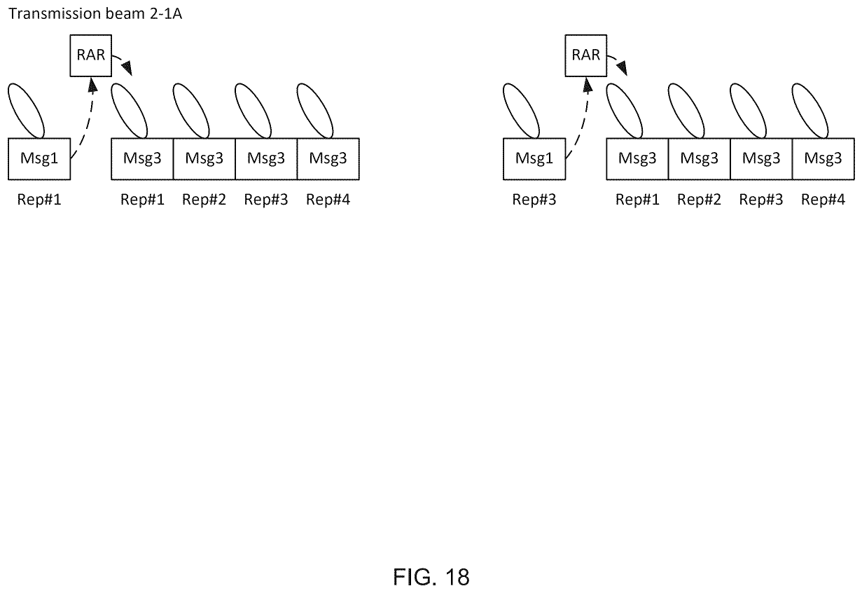

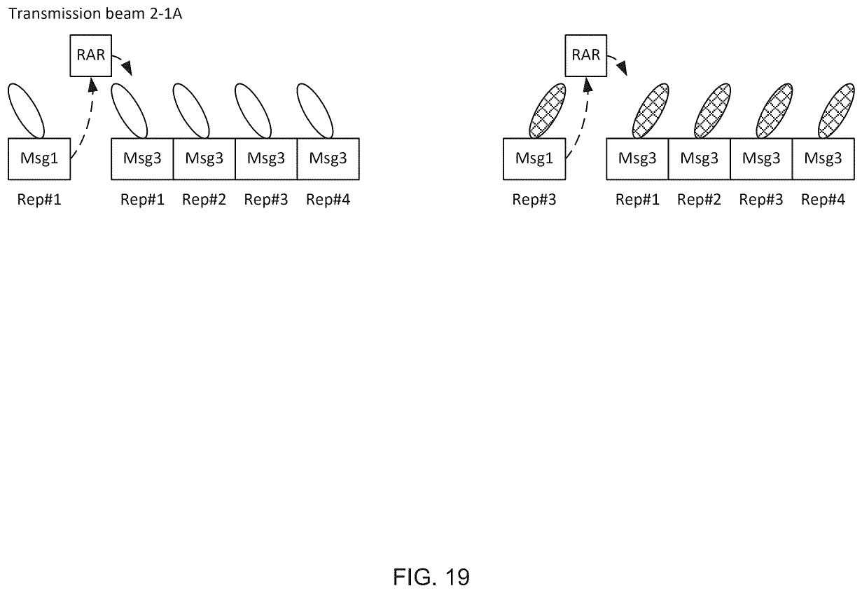

The same beam for all the Msg3 repetitions may be determined based on a beam for corresponding Msg1 repetition. In an example in FIG. 18, a plurality of Msg1 repetitions use the same beam, and one beam used for four Msg3 repetitions is a beam used for corresponding Msg1 repetition. In an example in FIG. 19, a plurality of Msg1 repetitions use different beams, and one beam used for four Msg3 repetitions is a beam used for corresponding Msg1 repetition.

### {{Transmission Beam 2-1B}}

The same beam for all the Msg3 repetitions may be determined based on a corresponding RAR.

Example: the beam may be determined by an explicit indication in the RAR. One field in the RAR may indicate a beam for the Msg3 repetitions. “The UE assumes that the indicated beam is obtained from a beam for Msg1 repetition” may be defined.

Example: the beam may be determined by an implicit indication, such as an RA-RNTI. For example, the beam may be determined based on an RO corresponding to an RA-RNTI used for a detected RAR.

### {{Transmission Beam 2-1C}}

The same beam for all the Msg3 repetitions may be determined based on a beam for all the Msg1 repetitions.

Example: if a plurality of Msg1 repetitions use the same beam, a beam for Msg3 repetitions may be the same as Transmission Beam 2-1A.

Example: if a plurality of Msg1 repetitions use different beams, a beam for Msg3 repetitions may follow a beam for the first/last/any Msg1 repetition.

### {Transmission Beam 2-2}

Different beams may be used for all the Msg3 repetitions.

### {{Transmission Beam 2-2A}}

A beam for a plurality of Msg3 repetitions may be determined based on a beam for all the Msg1 repetitions. If a plurality of Msg1 repetitions use different beams, a beam for a plurality of Msg3 repetitions may follow beams for the plurality of Msg1 repetitions.

Example: if the number of Msg1 repetitions is equal to the number of Msg3 repetitions, mapping between beams for a plurality of Msg1 repetitions and beams for a plurality of Msg3 repetitions may be one-to-one mapping.

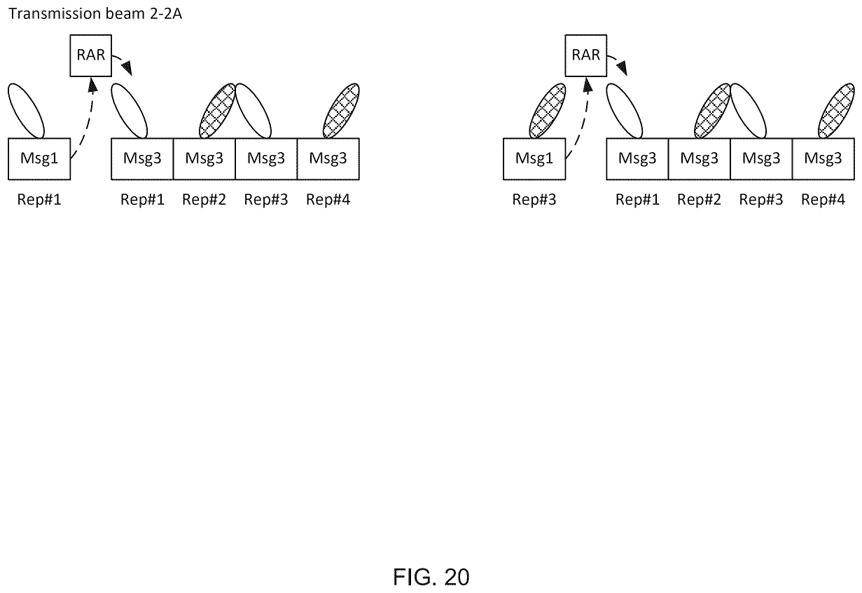

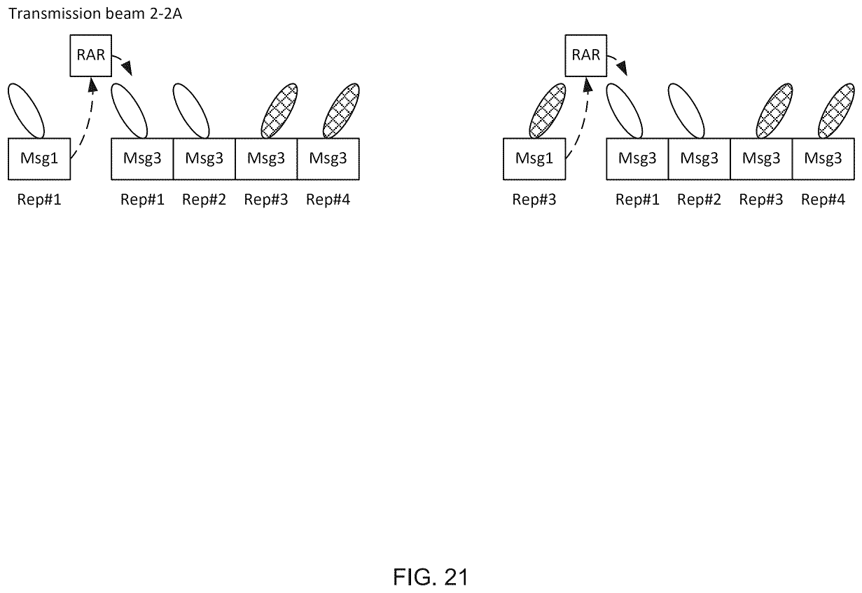

Example: if the number of Msg1 repetitions is less than the number of Msg3 repetitions, mapping between beams for a plurality of Msg1 repetitions and beams for a plurality of Msg3 repetitions may be sequential mapping or cyclic mapping. In an example in FIG. 20, two beams used for two Msg1 repetitions are cyclically applied to four beams used for four Msg3 repetitions (cyclic mapping). In an example in FIG. 21, respective beams used for two Msg1 repetitions are each applied twice sequentially to four beams used for four Msg3 repetitions (sequential mapping).

Example: if the number of Msg1 repetitions is greater than the number N of Msg3 repetitions, beams for N Msg3 repetitions may be beams for the first/last/any N Msg1 repetitions.

### {{Transmission Beam 2-2B}}

A beam for a plurality of Msg3 repetitions may be determined based on a corresponding RAR.

Example: the beam may be determined by an explicit indication in the RAR. One field in the RAR may indicate one or a plurality of beams for the Msg3 repetitions. “The UE assumes that the indicated beam is obtained from a beam for Msg1 repetition” may be defined.

According to this embodiment, the UE can, when performing Msg1 repetition and Msg3 repetition, appropriately determine a beam for the Msg3 repetition.

### Embodiment #3

This embodiment relates to the number of Msg3 repetitions.

The UE may receive indication information related to the number of repetitions of a Msg3. The UE may determine the number of repetitions of the Msg3, based on the indication information and information related to a repetition of a Msg1 in random access procedure including a repetition of the Msg3.

Interpretation of the number of Msg3 repetitions indicated by an RAR may depend on at least one of Embodiments #3-1 to #3-5 below.

### Embodiment #3-1

The interpretation of the number of Msg3 repetitions indicated by the RAR may depend on whether one or more Msg1 repetitions are performed in current RACH procedure.

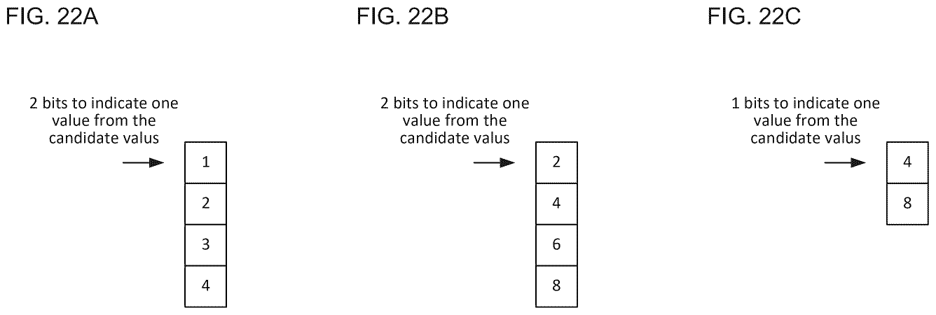

When Msg1 repetition is absent in the current RACH procedure, the interpretation of the number of Msg3 repetitions indicated by the RAR may follow a Rel-17 rule. In other words, two bits from an MCS field may be reused for the interpretation, based on four candidate values. In an example in FIG. 22A, 2 bits from the MCS field indicate one value from four candidate values for the number of Msg3 repetitions.

When Msg1 repetition is present in the current RACH procedure, at least one of the number of bits of the indication and the candidate values for the number of Msg3 repetitions indicated by the RAR may be different from the Rel-17 rule. For example, X bits from the MCS field may be used to indicate one value from up to 2x candidate values for the number of Msg3 repetitions. X may be equal to 2, may be less than 2, or may be greater than 2. The up to 2x candidate values may be defined in a specification, or may be configured by a PBCH/SIB1 PDSCH/RRC IE. The candidate values may not exceed an upper limit, such as Apr. 8, 2016/32/64. In an example in FIG. 22B, 2 bits from the MCS field indicate one value from four candidate values for the number of Msg3 repetitions. In an example in FIG. 22C, 1 bit from the MCS field indicates one value from two candidate values for the number of Msg3 repetitions.

When Msg1 repetition is present, a value/range of the required number of Msg3 repetitions may be greater than a value of Rel. 17. Accordingly, for a case with Msg1 repetition, a value defined/configured for the number of Msg3 repetitions may be different from a value for a case without Msg1 repetition.

### Embodiment #3-2

When a plurality of Msg1 repetitions are performed in the current RACH procedure, the interpretation of the number of Msg3 repetitions indicated by the RAR may depend on whether one RAR or a plurality of RARs are transmitted.

When a plurality of Msg1 repetitions are present in the current RACH procedure, at least one of the number of bits of the indication and the candidate values for the number of Msg3 repetitions may differ between a case (case 1) where only one RAR is transmitted for the plurality of Msg1 repetitions and a case (case 2) where a plurality of RARs are transmitted for the plurality of Msg1 repetitions.

For example, if only one RAR is transmitted for the plurality of Msg1 repetitions (case 1), X bits from an MCS field may be used to indicate one value from up to 2x candidate values for the number of Msg3 repetitions. X may be equal to 2, may be less than 2, or may be greater than 2. The up to 2x candidate values may be defined in a specification, or may be configured by a PBCH/SIB1

PDSCH/RRC IE. The up to 2x candidate values may be the same as candidate values configured for the UE supporting Msg3 repetition in Rel. 17. The candidate values may not exceed an upper limit, such as Apr. 8, 2016/32/64.

A new field of X bits in the RAR may be used to indicate one value from up to 2x candidate values for the number of Msg3 repetitions.

For example, if a plurality of RARs are transmitted for the plurality of Msg1 repetitions (case 2), Y bits from an MCS field may be used to indicate one value from up to 2Y candidate values for the number of Msg3 repetitions. Y may be equal to 2, may be less than 2, or may be greater than 2. The up to 2Y candidate values may be defined in a specification, or may be configured by a PBCH/SIB1 PDSCH/RRC IE. The up to 2x candidate values may be the same as candidate values configured for the UE supporting Msg3 repetition in Rel. 17. The candidate values may not exceed an upper limit, such as Apr. 8, 2016/32/64.

A new field of Y bits in the RAR may be used to indicate one value from up to 2Y candidate values for the number of Msg3 repetitions. 2 bits from an MCS field in the first RAR may be used to indicate one value from up to 4 candidate values for the number of Msg3 repetitions (as with Rel. 17). A new field of Y bits in the second or subsequent RAR may be used to indicate one value from up to 2Y candidate values for the number of Msg3 repetitions.

### Embodiment #3-3

(In a case where a base station can recognize the number of Msg1 repetitions,) the interpretation of the number of Msg3 repetitions indicated by the RAR may depend on the number of Msg1 repetitions in the current RACH procedure. For example, the case where the base station can recognize the number of Msg1 repetitions may be a case where a RACH resource pool is associated with the number of Msg1 repetitions or may be a case where only one number of repetitions is present for Msg1.

When a plurality of Msg1 repetitions are present in the current RACH procedure, at least one of the number of bits of the indication and the candidate values for the number of Msg3 repetitions may differ between cases of different numbers of Msg1 repetitions.

For example, if four Msg1 repetitions are present, X bits from an MCS field may be used to indicate one value from up to 2x candidate values for the number of Msg3 repetitions. X may be equal to 2, may be less than 2, or may be greater than 2. The up to 2^{X} candidate values may be defined in a specification, or may be configured by a PBCH/SIB1 PDSCH/RRC IE. The up to 2^{X} candidate values may be the same as candidate values configured for the UE supporting Msg3 repetition in Rel. 17. The candidate values may not exceed an upper limit, such as Apr. 8, 2016/32/64.

A new field of X bits in the RAR may be used to indicate one value from up to 2^{X} candidate values for the number of Msg3 repetitions. 2 bits from an MCS field in the first RAR may be used to indicate one value from up to 4 candidate values for the number of Msg3 repetitions (as with Rel. 17). A new field of X bits in the second or subsequent RAR may be used to indicate one value from up to 2^{X} candidate values for the number of Msg3 repetitions.

For example, if eight Msg1 repetitions are present, Y bits from an MCS field may be used to indicate one value from up to 2Y candidate values for the number of Msg3 repetitions. Y may be equal to 2, may be less than 2, or may be greater than 2. The up to 2^{Y} candidate values may be defined in a specification, or may be configured by a PBCH/SIB1 PDSCH/RRC IE. The up to 2^{X} candidate values may be the same as candidate values configured for the UE supporting Msg3 repetition in Rel. 17. The candidate values may not exceed an upper limit, such as Apr. 8, 2016/32/64.

A new field of Y bits in the RAR may be used to indicate one value from up to 2^{Y} candidate values for the number of Msg3 repetitions. 2 bits from an MCS field in the first RAR may be used to indicate one value from up to 4 candidate values for the number of Msg3 repetitions (as with Rel. 17). A new field of Y bits in the second or subsequent RAR may be used to indicate one value from up to 2^{Y} candidate values for the number of Msg3 repetitions.

### Embodiment #3-4

When a plurality of Msg1 repetitions are performed in the current RACH procedure, the interpretation of the number of Msg3 repetitions indicated by the RAR may depend on whether the same beam or different beams are used for the plurality of Msg1 repetitions.

When a plurality of Msg1 repetitions are present in the current RACH procedure, at least one of the number of bits of the indication and the candidate values for the number of Msg3 repetitions may differ between a case where the plurality of Msg1 repetitions use the same beam and a case where the plurality of Msg1 repetitions use different beams.

For example, if the plurality of Msg1 repetitions use the same beam, X bits from an MCS field may be used to indicate one value from up to 2^{X} candidate values for the number of Msg3 repetitions. X may be equal to 2, may be less than 2, or may be greater than 2. The up to 2^{X} candidate values may be defined in a specification, or may be configured by a PBCH/SIB1 PDSCH/RRC IE. The up to 2^{X} candidate values may be the same as candidate values configured for the UE supporting Msg3 repetition in Rel. 17. The candidate values may not exceed an upper limit, such as Apr. 8, 2016/32/64.

A new field of X bits in the RAR may be used to indicate one value from up to 2^{X} candidate values for the number of Msg3 repetitions. 2 bits from an MCS field in the first RAR may be used to indicate one value from up to 4 candidate values for the number of Msg3 repetitions (as with Rel. 17). A new field of X bits in the second or subsequent RAR may be used to indicate one value from up to 2^{X} candidate values for the number of Msg3 repetitions.

For example, if the plurality of Msg1 repetitions use different beams, Y bits from an MCS field may be used to indicate one value from up to 2^{Y} candidate values for the number of Msg3 repetitions. Y may be equal to 2, may be less than 2, or may be greater than 2. The up to 2^{Y} candidate values may be defined in a specification, or may be configured by a PBCH/SIB1 PDSCH/RRC IE. The up to 2^{X} candidate values may be the same as candidate values configured for the UE supporting Msg3 repetition in Rel. 17. The candidate values may not exceed an upper limit, such as Apr. 8, 2016/32/64.

A new field of Y bits in the RAR may be used to indicate one value from up to 2^{Y} candidate values for the number of Msg3 repetitions. 2 bits from an MCS field in the first RAR may be used to indicate one value from up to 4 candidate values for the number of Msg3 repetitions (as with Rel. 17). A new field of Y bits in the second or subsequent RAR may be used to indicate one value from up to 2^{Y} candidate values for the number of Msg3 repetitions.

### Embodiment #3-5

The interpretation of the number of Msg3 repetitions indicated by the RAR may depend on several combinations of Embodiments #3-2, #3-3, and #3-4.

For example, the interpretation may depend on a combination of Embodiments #3-2 and #3-3.

For example, the interpretation may depend on a combination of Embodiments #3-2 and #3-4.

For example, the interpretation may depend on a combination of Embodiments #3-3 and #3-4.

For example, the interpretation may depend on a combination of Embodiments #3-2, #3-3, and #3-4.

According to this embodiment, the UE can appropriately determine the number of Msg3 repetitions.

### <Supplement>

Operation for at least one of the above-described embodiments may be applied only to a UE that has reported specific UE capabilities or that supports the specific UE capabilities.

The specific UE capabilities may indicate at least one of the following:
supporting specific processing/operation/control/information for at least one of the above-described embodiments,
supporting simultaneous Msg1 repetition and Msg3 repetition (combination of/joint operation for Msg1 repetition and Msg3 repetition),
supporting both Msg1 repetition and Msg3 repetition in one RACH procedure in a case (case 1) where one RAR for a plurality of Msg1 repetitions is transmitted,
supporting both Msg1 repetition and Msg3 repetition in one RACH procedure in a case (case 2) where a plurality of RARs for a plurality of Msg1 repetitions are transmitted,
supporting both Msg1 repetition and Msg3 repetition in one RACH procedure in a case where the same transmission beam is used for a plurality of Msg1 repetitions,
supporting both Msg1 repetition and Msg3 repetition in one RACH procedure in a case where different transmission beams are used for a plurality of Msg1 repetitions,
supporting determination of a beam for one or more Msg3 repetitions, depending on one or more beams for one or more Msg1 repetitions, and
supporting reuse/interpretation of the number of Msg3 repetitions, depending on one or more Msg1 repetitions.

The specific UE capabilities described above may be a capability applied across all the frequencies (commonly regardless of frequency), a capability per frequency (for example, a cell, a band, a BWP), a capability per frequency range (for example, Frequency Range 1 (FR1), FR2, FR3, FR4, FR5, FR2-1, FR2-2), or a capability per subcarrier spacing (SCS).

The specific UE capabilities described above may be a capability applied across all the duplex modes (commonly regardless of duplex mode), or a capability per duplex mode (for example, time division duplex (TDD), frequency division duplex (FDD)).

Operation for at least one of the above-described embodiments may be applied to a case where specific information associated with the above-described embodiments is configured for the UE by higher layer signaling. For example, the specific information may be information indicating enabling of operation for at least one of the above-described embodiments, any RRC parameter for a specific release (for example, Rel. 18), or the like.

In a case where the UE does not support operation for at least one of the specific UE capabilities described above or is not configured with the specific information, the UE may apply, for example, Rel-15/16/17 operation.

### (Supplementary Note A)

Regarding one embodiment of the present disclosure, the following supplementary notes of the invention will be given.

### {Supplementary Note 1}

A terminal including:
a transmitting section that transmits first capability information related to a capability for a repetition of a message 1, and second capability information related to a capability for a repetition of a message 3; and
a control section that determines, based on the first capability information and the second capability information, whether to perform first random access procedure including the repetition of the message 1 and the repetition of the message 3 or second random access procedure not including at least one of the repetition of the message 1 and the repetition of the message 3.

### {Supplementary Note 2}

The terminal according to supplementary note 1, wherein the control section uses, for the first random access procedure, a first random access resource and uses, for the second random access procedure, a second random access resource different from the first random access resource.

### {Supplementary Note 3}

The terminal according to supplementary note 1 or 2, wherein the control section determines whether to perform the first random access procedure or the second random access procedure, based on comparison between reference signal received power and a threshold.

### {Supplementary Note 4}

The terminal according to any one of supplementary notes 1 to 3, wherein the control section controls repetition of information related to at least one of a maximum number of repetitions of the message 1 and a threshold for reference signal received power.

### (Supplementary Note B)

Regarding one embodiment of the present disclosure, the following supplementary notes of the invention will be given.

### {Supplementary Note 1}

A terminal including:
a receiving section that receives information related to first random access procedure including a repetition of a message 1; and
a control section that, based on the information, uses, for the first random access procedure, a first random access resource and uses, for second random access procedure not including the repetition of the message 1, a second random access resource different from the first random access resource.

### {Supplementary Note 2}

The terminal according to supplementary note 1, wherein the information includes at least one of the number of preamble indices for the first random access resource and a first preamble index for the first random access resource.

### {Supplementary Note 3}

The terminal according to supplementary note 1 or 2, wherein the control section uses, for the first random access procedure, a first random access channel occasion and uses, for the second random access procedure, a second random access channel occasion different from the first random access channel occasion.

### {Supplementary Note 4}

The terminal according to any one of supplementary notes 1 to 3, wherein the control section determines a first random access channel occasion for the first random access procedure, based on at least one of a mask index and a second random access channel occasion for the second random access procedure.

### (Supplementary Note C)

Regarding one embodiment of the present disclosure, the following supplementary notes of the invention will be given.

### {Supplementary Note 1}

A terminal including:
a receiving section that receives information related to random access procedure including a plurality of repetitions of a message 1 and a plurality of repetitions of a message 3; and
a control section that, based on the information and based on one or more first beams to be used for the plurality of repetitions of the message 1, determines one or more second beams to be used for the plurality of repetitions of the message 3.

### {Supplementary Note 2}

The terminal according to supplementary note 1, wherein the control section determines the one or more second beams from among the one or more first beams.

### {Supplementary Note 3}

The terminal according to supplementary note 1 or 2, wherein one random access response is transmitted for the plurality of repetitions of the message 1.

### {Supplementary Note 4}

The terminal according to any one of supplementary notes 1 to 3, wherein one random access response is transmitted for each of the plurality of repetitions of the message 1.

### (Supplementary Note D)

Regarding one embodiment of the present disclosure, the following supplementary notes of the invention will be given.

### {Supplementary Note 1}

A terminal including:
a receiving section that receives indication information related to the number of repetitions of a message 3; and
a control section that determines the number of repetitions of the message 3, based on the indication information and information related to a repetition of a message 1 in random access procedure including a repetition of the message 3.

### {Supplementary Note 2}

The terminal according to supplementary note 1, wherein the information relates to the number of repetitions of the message 1.

### {Supplementary Note 3}

The terminal according to supplementary note 1 or 2, wherein the information relates to the number of random access responses to the message 1.

### {Supplementary Note 4}

The terminal according to any one of supplementary notes 1 to 3, wherein the information relates to the number of beams used for the repetition of the message 1.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

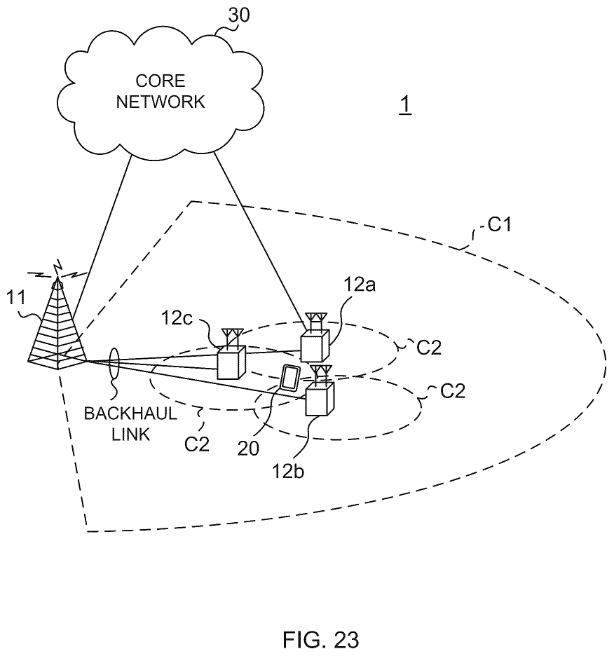

FIG. 23 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-S-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a given search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

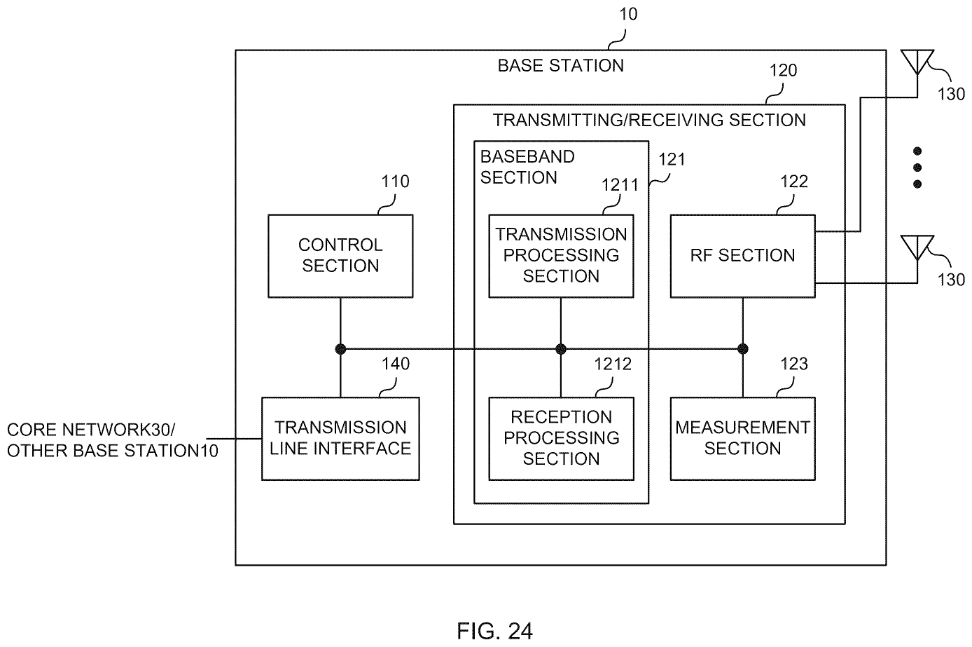

FIG. 24 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may receive first capability information related to a capability for a repetition of a message 1, and second capability information related to a capability for a repetition of a message 3. The control section 110 may determine, based on the first capability information and the second capability information, whether to perform first random access procedure including the repetition of the message 1 and the repetition of the message 3 or second random access procedure not including at least one of the repetition of the message 1 and the repetition of the message 3.

The transmitting/receiving section 120 may transmit information related to first random access procedure including a repetition of a message 1. Based on the information, the control section 110 may use, for the first random access procedure, a first random access resource and may use, for second random access procedure not including the repetition of the message 1, a second random access resource different from the first random access resource.

The transmitting/receiving section 120 may transmit information related to random access procedure including a plurality of repetitions of a message 1 and a plurality of repetitions of a message 3. Based on the information, the control section 110 may determine one or more second beams to be used for the plurality of repetitions of the message 3, based on one or more first beams to be used for the plurality of repetitions of the message 1.

The transmitting/receiving section 120 may transmit indication information related to the number of repetitions of a message 3. The control section 110 may determine the number of repetitions of the message 3, based on the indication information and information related to a repetition of a message 1 in random access procedure including a repetition of the message 3.

### (User Terminal)

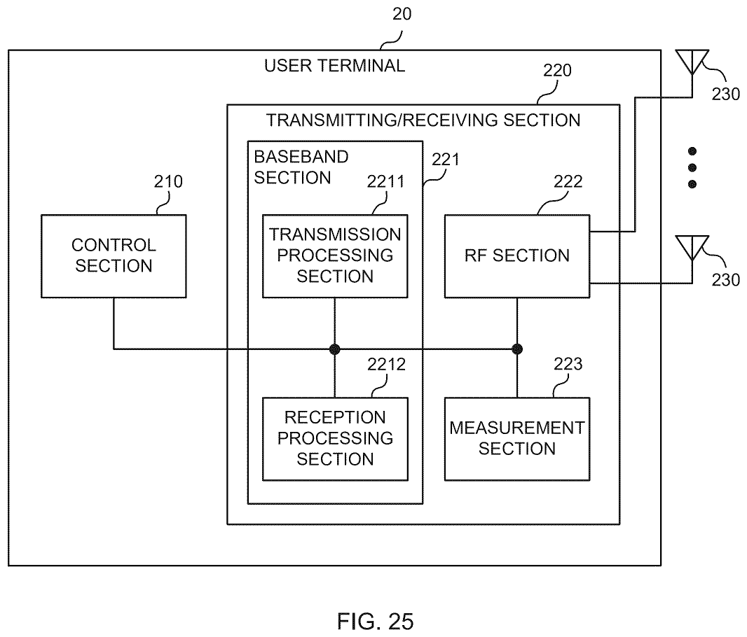

FIG. 25 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-S-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may transmit first capability information related to a capability for a repetition of a message 1, and second capability information related to a capability for a repetition of a message 3. The control section 210 may determine, based on the first capability information and the second capability information, whether to perform first random access procedure including the repetition of the message 1 and the repetition of the message 3 or second random access procedure not including at least one of the repetition of the message 1 and the repetition of the message 3.

The control section 210 may use, for the first random access procedure, a first random access resource and may use, for the second random access procedure, a second random access resource different from the first random access resource.

The control section 210 may determine whether to perform the first random access procedure or the second random access procedure, based on comparison between reference signal received power and a threshold.

The control section 210 may control repetition of information related to at least one of a maximum number of repetitions of the message 1 and a threshold for reference signal received power.

The transmitting/receiving section 220 may receive information related to first random access procedure including a repetition of a message 1. Based on the information, the control section 210 may use, for the first random access procedure, a first random access resource and may use, for second random access procedure not including the repetition of the message 1, a second random access resource different from the first random access resource.

The information may include at least one of the number of preamble indices for the first random access resource and a first preamble index for the first random access resource.

The control section 210 may use, for the first random access procedure, a first random access channel occasion and may use, for the second random access procedure, a second random access channel occasion different from the first random access channel occasion.

The control section 210 may determine a first random access channel occasion for the first random access procedure, based on at least one of a mask index and a second random access channel occasion for the second random access procedure.

The transmitting/receiving section 220 may receive information related to random access procedure including a plurality of repetitions of a message 1 and a plurality of repetitions of a message 3. Based on the information, the control section 210 may determine one or more second beams to be used for the plurality of repetitions of the message 3, based on one or more first beams to be used for the plurality of repetitions of the message 1.

The control section 210 may determine the one or more second beams from among the one or more first beams.

One random access response may be transmitted for the plurality of repetitions of the message 1.

One random access response may be transmitted for each of the plurality of repetitions of the message 1.

The transmitting/receiving section 220 may receive indication information related to the number of repetitions of a message 3. The control section 210 may determine the number of repetitions of the message 3, based on the indication information and information related to a repetition of a message 1 in random access procedure including a repetition of the message 3.

The information may relate to the number of repetitions of the message 1.

The information may relate to the number of random access responses to the message 1.

The information may relate to the number of beams used for the repetition of the message 1.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

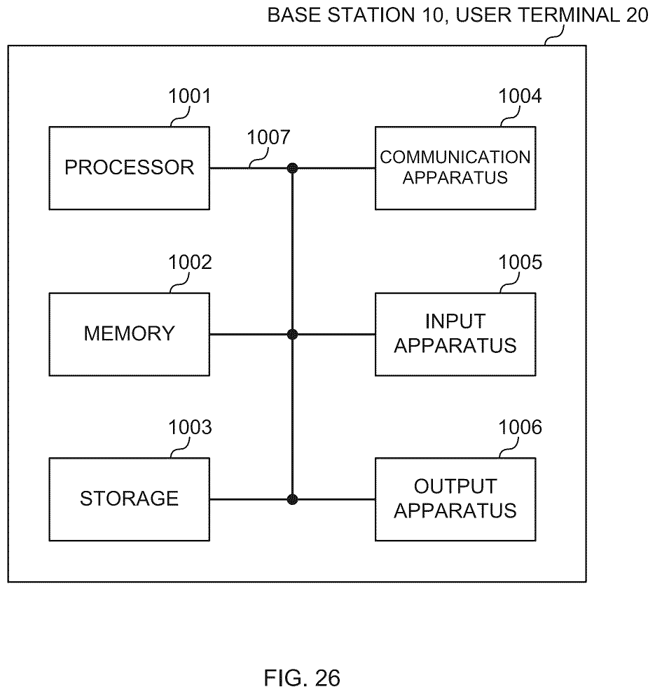

For example, a base station, a user terminal, and so on according to one embodiment of the present disclosure may function as a computer that executes the processes of the radio communication method of the present disclosure. FIG. 26 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIS.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB/RB group/set/pair,” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for given numerology in a given carrier. Here, a common RB may be specified by an index of the RB based on the common reference point of the carrier. A PRB may be defined by a given BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of given information (for example, reporting of “X holds”) does not necessarily have to be reported explicitly, and can be reported implicitly (by, for example, not reporting this given information or reporting another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, a case that a base station transmits information to a terminal and a case that the base station indicates, for the terminal, control/operation based on the information may be interchangeably interpreted.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type).

Note that at least one of a base station and a mobile station also includes an apparatus which does not necessarily move during communication operation. For example, at least one of a base station and a mobile station may be an Internet of Things (IoT) device such as a sensor.

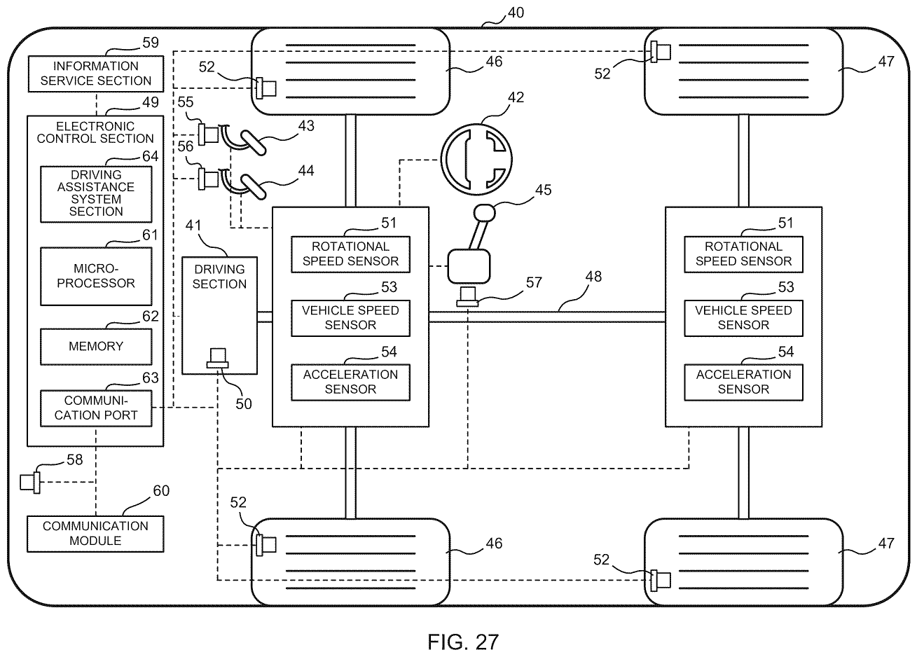

FIG. 27 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

In the present disclosure, “equal to or smaller than,” “smaller than,” “equal to or larger than,” “larger than,” “equal to,” and the like may be interchangeably interpreted. In the present disclosure, words such as “good,” “poor,” ““large,” “small,” “high,” “low,” “early,” “late,” “wide,” “narrow,” and the like may be interchangeably interpreted irrespective of positive degree, comparative degree, and superlative degree. In the present disclosure, expressions obtained by adding “i-th” (i is any integer) to words such as “good,” “poor,” “large,” “small,” “high,” “low,” “early,” “late,” “wide,” “narrow,” and the like may be interchangeably interpreted irrespective of positive degree, comparative degree, and superlative degree (for example, “highest” may be interpreted as “i-th highest,” and vice versa).

In the present disclosure, “of,” “for,” “regarding,” “related to,” “associated with,” and the like may be interchangeably interpreted.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a receiving section that receives indication information related to the number of repetitions of a message 3; and
a control section that determines the number of repetitions of the message 3, based on the indication information and information related to a repetition of a message 1 in random access procedure including a repetition of the message 3.

2. The terminal according to claim 1, wherein
the information relates to the number of repetitions of the message 1.

3. The terminal according to claim 1, wherein
the information relates to the number of random access responses to the message 1.

4. The terminal according to claim 1, wherein
the information relates to the number of beams used for the repetition of the message 1.

5. A radio communication method for a terminal, the radio communication method comprising:
receiving indication information related to the number of repetitions of a message 3; and
determining the number of repetitions of the message 3, based on the indication information and information related to a repetition of a message 1 in random access procedure including a repetition of the message 3.

6. A base station comprising:
a transmitting section that transmits indication information related to the number of repetitions of a message 3; and
a control section that determines the number of repetitions of the message 3, based on the indication information and information related to a repetition of a message 1 in random access procedure including a repetition of the message 3.
